(19) United States
(12) Patent Application Publication
(10) Pub. No.: US 2003/0178757 A1
(43) Pub. Date: Sep. 25, 2003

(54) Spring element, in particular for a torsional vibration damper

(76) Inventors: Ulrich Rohs, Duren (DE); Christoph Drager, Inden (DE); Werner Brandwitte, Langerwehe (DE); Dietmar Heidingfeld, Aachen (DE)

Correspondence Address: WILLIAM COLLARD, COLLARD & ROE, P.C., 1077 NORTHERN BOULEVARD, ROSLYN, NY, 11576, US

(21) Appl. No.: 10/257,061

(22) PCT Filed: Apr. 9, 2001
(86) PCT No.: PCT/DE01/01378

(30) Foreign Application Priority Data
Apr. 8, 2000 (DE) 100 17 688.7

(51) Int. Cl. F16D 57/02; F16F 1/18

(52) U.S. Cl. 267/158; 188/291

(57) ABSTRACT

The invention relates to a spring element, comprising a sprung sheet (16, 17) which co-operates with at least one rolling body (20) in a first region (23) of the device. The rolling body impinges on a stopper (22) in a second region (25) of the device and opposite to the first region of the device with the sprung sheet. The stopper and sprung sheet are mounted in a displaceable manner relative to each other and, on such a displacement, the sprung sheet is bent. The above spring element may be applied to advantage in torsional vibration dampers (1) and preferably comprises a damping unit.

This invention relates to a spring element, in particular for torsional vibration dampers.

Spiral springs, which cooperate with a friction device, are used for torsional vibration dampers. Fluids pressed through a narrow opening or mechanical friction surfaces can be sued as friction device.

Known torsional vibration dampers are manufactured from a plurality of components, resulting in high manufacturing costs.

The object of the invention is to propose a novel spring element which enables simple construction of a torsional vibration damper and which can be used for further applications.

This task is solved using a spring element, having a sprung sheet cooperating in a first region with at least one rolling body. The rolling body acts against a stopper opposite the first region of the sprung sheet in a second region. The stopper and the sprung sheet are mounted displaceably relative to one another and the sprung sheet is bent in such a relative movement.

The whole spring element can be made up of very few components, extremely easy to manufacture. Manufacture is therefore favourable. In addition, the spring element can be realised in the narrowest axial structural space and it can be combined with a wide range of damper devices.

The sprung sheet can be prestressed against the rolling body to keep the rolling body secure in the case of strong mechanical damage, such as high vibrations or radial forces.

Further advantageous details of the spring element will emerge from the sub-claims.

It is an advantage, for example, if the sprung sheet has a stiffening bead. Such a bead enables sprung sheets to be manufactured with an extremely high degree of stiffness at minimal material costs. Moreover, due to the design of the beads identical sprung sheets can exhibit differing characteristics, which are matched to the respective application in their dimensions.

In order to guide the rolling bodies on secure paths, it is suggested that the sprung sheet has a guide for the rolling bodies.

This guide is formed advantageously by at least partial deformation of the sprung sheet. The sprung sheet thus assumes not only pressing but also guiding tasks.

A simple embodiment provides that the guide of the sprung sheet is formed at least partially via an opening in the sprung sheet. For example, a rhomboidal opening simultaneously permits the rolling body to be guided and moved in an axial direction.

To move sprung sheet and stopper apart in their relative movement to one another it is suggested that the guide of the sprung sheet has an opposed conical form at opposite ends in the direction of movement. Narrowing the guides in these opposite regions results in the rolling body—whenever it enters this region—pressing stopper and sprung sheet apart.

Since stopper and sprung sheet should be able to rotate relative to one another over a certain section only or at a certain angle of rotation, it is suggested that the guide of the sprung sheet limits the possible relative movement between sprung sheet and stopper. To this end the guide may exhibit a particularly steep inclination at ends opposite in direction of movement, which limits the path of the rolling body and acts as a soft stopper.

In the area in which especially low friction between the rolling body and the sprung sheet is desirable, it is suggested to form the guide of the sprung sheet for point or extended contact between sprung sheet and rolling body. This is achieved in the case of a spherical rolling body for example where the radius of the guide is slightly greater than the radius of the sphere.

In areas where increased damping is desired it is suggested that the guide of the sprung sheet is designed for surface contact between sprung sheet and rolling body. With a spherical rolling body this is achieved for example with a guide which has a groove with a radius approximating the radius of the rolling body.

However, a guide can also be achieved by an especially elastic or plastic deformable spring element which deforms under pressure from the rolling body on the sprung sheet around the rolling body.

In the interests of achieving particularly strong damping in the vicinity of the first region between sprung sheet and rolling body, it is suggested to provide a friction surface at this point. At the same time the guide can hereby take on the function of a damping device.

In order to utilise the entire spring length or the entire spring radius in its resilience in the case of saucer springs, it is suggested, that the first region be arranged in an edge region of the sprung sheet.

To date it has been suggested to position the guide for the rolling body in the region of the sprung sheet. Additionally or alternatively the guide can also be provided on the stopper.

In the vicinity of the stopper also the guide can be at least partially formed by deformation of the stopper. Likewise the guide of the stopper can be at least partially formed by an opening in the stopper and the guide of the stopper can display an opposed conical form on opposite ends in the direction of movement.

Furthermore the guide of the stopper can also limit the possible relative movement between sprung sheet and stopper.

Finally the guide of the stopper, as for the sprung sheet, can likewise be designed at least selectively for extended or two-dimensional contact between stopper and rolling body.

To increase the damping the second region can also have a friction surface.

The sprung sheets enable many variant embodiments. For example several sprung sheets can be ordered radially behind one another or*several sprung sheets can be arranged axially behind one another.

A particularly advantageous embodiment provides for two sprung sheets to be arranged on opposite sides of the stopper. Here it is suggested that there is at least one rolling body arranged advantageously between each sprung sheet and stopper.

Use of several opposite sprung sheets with interposed rolling bodies allows a unit comprised of sprung sheets and rolling bodies and optionally an interposed stopper to be premounted. In this case the sprung sheets are preferably interconnected via riveting.

In a preferred embodiment spheres are used as rolling bodies. It is however also possible to use rollers as rolling bodies. These rollers can also have an oval cross-section in order to increase between stopper and sprung sheet the distance between the parts where there is relative movement.

Because the spring element should manage with the least possible grease or even without grease, it is suggested to use a particularly hard material such as titanium or ceramic for the rolling bodies. A particularly beneficial variant in terms of price provides rolling bodies of steel.

Depending on the application lubrication can also be provided in the region of the rolling body.

To achieve a properly proportioned distribution of forces and so as not to overstress the rolling bodies, it is suggested that preferably several rolling bodies are arranged in parallel.

In a simple embodiment a spring element for rotation movements has a stopper which adjoins a first component fixed on an axle. This first component is preferably a drive disc connected to the axle.

The stopper is connected to the first component preferably by welding. A good connection is however also achieved via positive locking which is realised preferably by beads or lock seams. An alternative embodiment provides the stopper to be connected to the first component by frictional connection, such as for example via a press fit.

For the first component to achieve optimally coordinated oscillation behaviour provision is made for the first component to have additional mass. This additional mass enables the mass of the first component to be varied in a defined manner. By designing the first component as a drive disc the additional mass is preferably at the radial outer edge to effect a considerable moment of inertia with the least possible mass.

As preferred application the first component is designed together with the stopper as primary part of a torsional vibration damper. It can thus be connected to an axle driven by the motor, advantageously has a discoid radial extension and in the radial outer region has a transmitter mark. In the outermost region is the additional mass, extending concentrically to the axle connected to the motor.

For practical use of the spring element the sprung sheet adjoins a second component preferably mounted on an axle. The second component can be mounted substantially by the connection between spring, rolling body and stopper or can be mounted substantially on an axle. Depending on application the bearing function prevails at one point or another.

It is an advantage if the second component is designed as secondary part of a torsional vibration damper. This secondary part then has a device for fastening to a coupling. It is preferably designed as a rotationally symmetrical disc with two opposed flanges.

A variant embodiment provides that the sprung sheet is connected to the second component by positive locking, preferably by riveting. This is beneficial in manufacture and has proven itself well in practice.

As an alternative to this it is provided that the sprung sheet is connected to the second component by screwing.

It is especially advantageous if a shielding plate is arranged between sprung sheet and second component. This shielding plate between sprung sheet and second component is preferably connected to the first component and then extends inwards from radially outwards. Its purpose is to keep away dust particles which are borne from outside, for example from the coupling the sprung sheet, so that the rolling procedure between the rolling bodies, the sprung sheet and the stopper is not impaired. Both when the spring element is operated dry and greased due to the structure of the spring element it should be ensured that no contaminant particles penetrate the region of the rolling bodies.

As mentioned previously it is possible to hold the sprung sheet and the second component without another bearing. It is however suggested to arrange a bearing between the second component and the axle. This bearing is preferably provided radially inside the rolling bodies.

Between the second component and axle the bearing can have a bearing shell which is preferably designed L-shaped. A bearing shell is used to form both an axial bearing and a radial bearing.

To satisfy the specific bearing requirements in the region of the radial bearings and of the axial bearing or to have the effect of damping in defined areas, it is suggested that the bearing shell have an axial bearing with a first shell element and a radial bearing with a second shell element. These shell elements can thus be manufactured from various materials and thus adapted optimally. It is understood that an L-shaped shell element can also comprise two different materials to fulfil the same function.

Additionally or alternatively to the bearing in the region of a central axis the first and/or second region can also be designed as a bearing. In the region of the rolling bodies a bearing function is created which can replace the central bearing or at least support it.

In a variant embodiment having a first and a second component it is suggested that an outer peripheral surface of the first component and an inner peripheral surface of the second component be designed as a bearing. The outer peripheral surface of the first component can be designed integrally to the first component or it can be attached as an additional element to the first component.

An advantageous structure of the spring element provides that a bearing is configured between first and second component, at a distance from the axis. This allows the rolling bodies to be arranged radially outside the bearing.

The sprung sheet can have a wide range of forms and one or more sprung sheets can be used for one spring element. It is an advantage if the spring element is constructed substantially centrically to an axis of rotation. In this case for example tangentially arranged sprung sheets can be used. It is, however, especially advantageous if the sprung sheet is designed as a saucer spring. This construction as saucer spring allows a particularly simple structure and includes the option of having one saucer spring cooperating simply with many rolling bodies.

An interesting structure arises also from the stopper or only the stopper having one saucer spring. More structural space in an axial direction of the spring element can be utilised for the spring function.

Stopper and sprung sheet could be designed to move laterally to one another. With respect to a compact structure of the spring element it is however advantageous if the stopper and the sprung sheet are mounted to rotate relatively to one another. This is especially a considerable advantage when using a saucer spring.

A tendency of the spring element to wobble required in many cases is created in that first and/or second region for rotational mobility enable additional mobility between stopper and sprung sheet. Whereas the rotatory mobility between stopper and sprung sheet acts in bending the sprung sheet and thus in the basic function of the spring element, axial or warped forces are compensated by the additional mobility between stopper and sprung sheet.

It is provided that the spring element has damping means for use as oscillating damper. It is understood that all damping devices known in the area of torsional vibration dampers, such as in particular hydraulic and mechanical dampers, can be used as dampers.

It is advantageous if the damping agent is arranged on the sprung sheet or on the second component and works against the stopper or the first component. In the process the damping agent can be arranged both on the radial outer region of the sprung sheet and on the radial inner region of the sprung sheet. Depending on construction of the spring element the structurally easiest and most effective arrangement is to be selected here.

Another embodiment provides that the damping agent is arranged on the stopper or on the first component and acts against the sprung sheet or the second component. Also this method contrary to the abovedescribed construction enables a damping agent for the inventive spring element to be mounted. In this variant in particular it is advantageous if the damping agent is arranged between the radial outer end of the sprung sheet and the radial inner end of the sprung sheet, since in most cases there is sufficient structural space available in this intermediate area for additional damping agent.

It is an advantage if the damping agent has an effective surface with fine profiling. This friction surface converts torsional vibration energy into heat and thus results in effective damping.

It is also suggested that the damping agent have an effective surface with an axial incline. If the spring element is constructed substantially centrically to an axis of rotation, then the effect of this axial incline during rotatory movement of the sprung sheet is excursion of the sprung sheet and of the damping agent acting against the sprung sheet and thus an increased power action in the vicinity of the friction surface, resulting in increased damping.

The damping agent can also have an effective surface with a radial incline. In this case also effective surface and countersurface can be configured such that with relative movement of the surfaces to one another there is an increase in force acting against and thus in friction.

Simple control of the damping is achieved that a part of the effective surface is designed without an incline. Whereas in this region damping is minimal or altogether absent, in the other regions there is increased contact force and thus increasing damping. In particular with only very slight movements between stopper and sprung sheet this control enables the damping to be kept low or discontinued, while when the elements undergo greater movement relative to one another increased damping becomes effective.

Another control device provides that the damping is varied relative to the speed of the rotatory motion of stopper and sprung sheet. To this end it is suggested that the damping agent has a mass which is subjected to centrifugal force during rotation such that it alters the damping. For example the centrifugal force can act as a radial force component which acts directly on a radially adjacent damping agent or indirectly alters the contact force of a damping agent adjacent axially or diagonally.

High damping force and a simple mechanical structure can be achieved for example by the damping agent having a damping adjustment spring.

Depending on construction of the spring element it can be an advantage here that the damping adjustment spring is positioned coaxially to the spring element or that the damping adjustment spring is positioned radially offset to an axis of rotation. This makes it possible to have substantial damping forces act uniformly distributed on the periphery of the spring element.

Another possibility of damping is created by the sprung sheet being designed such that, as a result of the centrifugal force acting on the mass of the spring during rotation, the contact force of the sprung sheet is altered on the rolling bodies. This enables a damping device to be provided without additional structural parts.

This advantage can also be achieved by the sprung sheet being designed such that during rotation the contact force of the sprung sheet on a bearing shell is altered. Due to this altered contact force the friction is changed and thus the damping of the system.

Another option for adapting the system according to the present invention to various requirements is achieved by two sprung sheets arranged on opposite sides of the stopper having different resilient strengths.

Other effects also arise, whereby rolling bodies positioned on opposite sides of the stopper are guided along diverging and/or converging paths.

A simple design type of a damping agent provides that it has at least one arm extending in a peripheral direction, which preferably acts radially against a friction surface. Here it is advantageous if the arm is connected to the stopper or the first component and the friction surface is connected to the sprung sheet.

The spring element can especially be used for mechanical torsional vibration dampers. But it is also suited to any other torsional vibration dampers, such as for example a torque converter.

For example, the arrangement of friction coatings on various positions can increase the damping properties of the sprung element. An advantageous embodiment provides that the position of the contact areas is such that there is forced slippage between sprung sheet and stopper.

Such forced slippage can be created by two sprung sheets rotatable about a rotational axis and connected together torsionally rigid act on an interposed stopper and the connecting axle is positioned between the first and second contact areas at an angle to the rotation axis.

It is understood that the sprung elements can be provided on the primary side or the stopper on the secondary side, or the sprung elements can be provided on the secondary side or the stopper on the primary side of the torsional vibration damper, without the way of the invention being influenced thereby.

A plurality of embodiments for spring elements according to the present invention and their use as torsional vibration damper is illustrated in the diagram and is explained in greater detail hereinbelow, wherein:

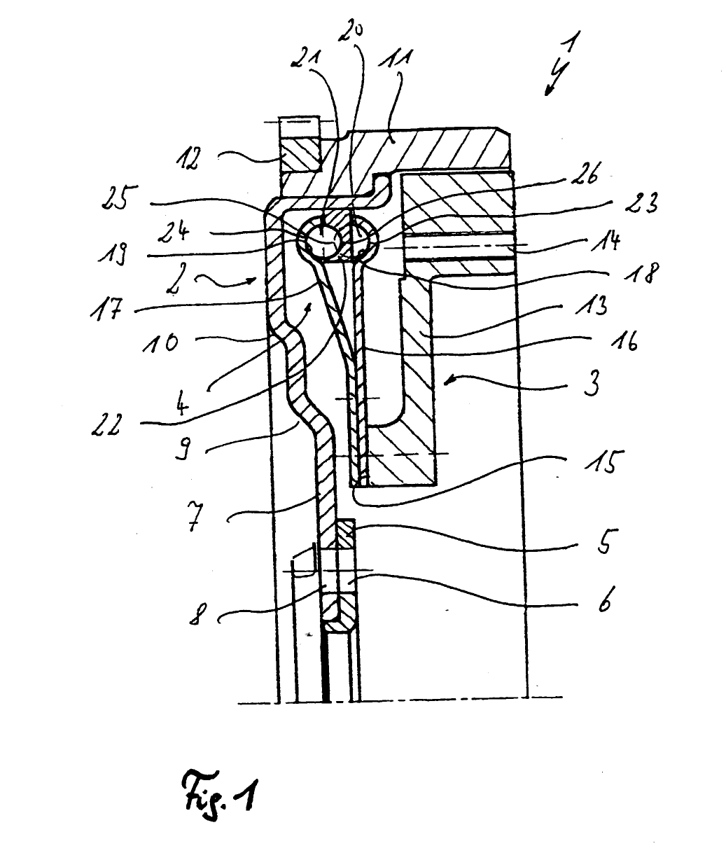

FIG. 1 shows a section through a torsional vibration damper with a spring element according to the present invention,

FIG. 2 shows a section through a torsional vibration damper with spring element and bearing,

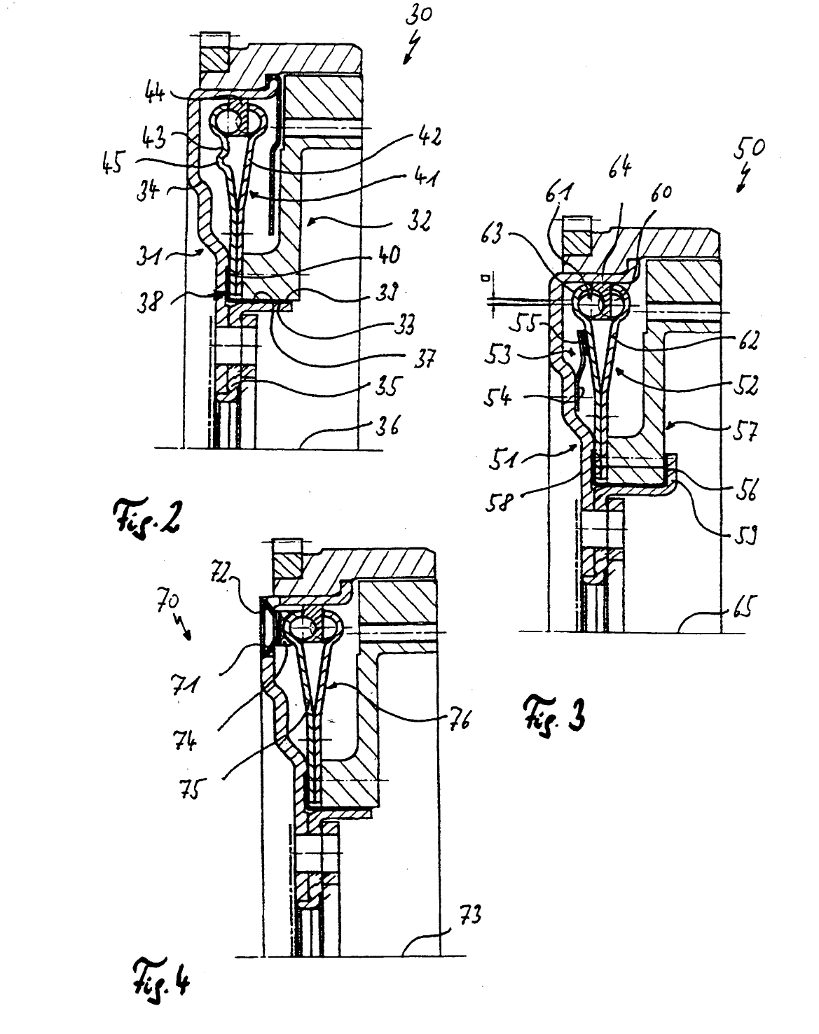

FIG. 3 shows a section through a torsional vibration damper with damping adjustment spring,

FIG. 4 shows a section through a torsional vibration damper with two damping adjustment springs,

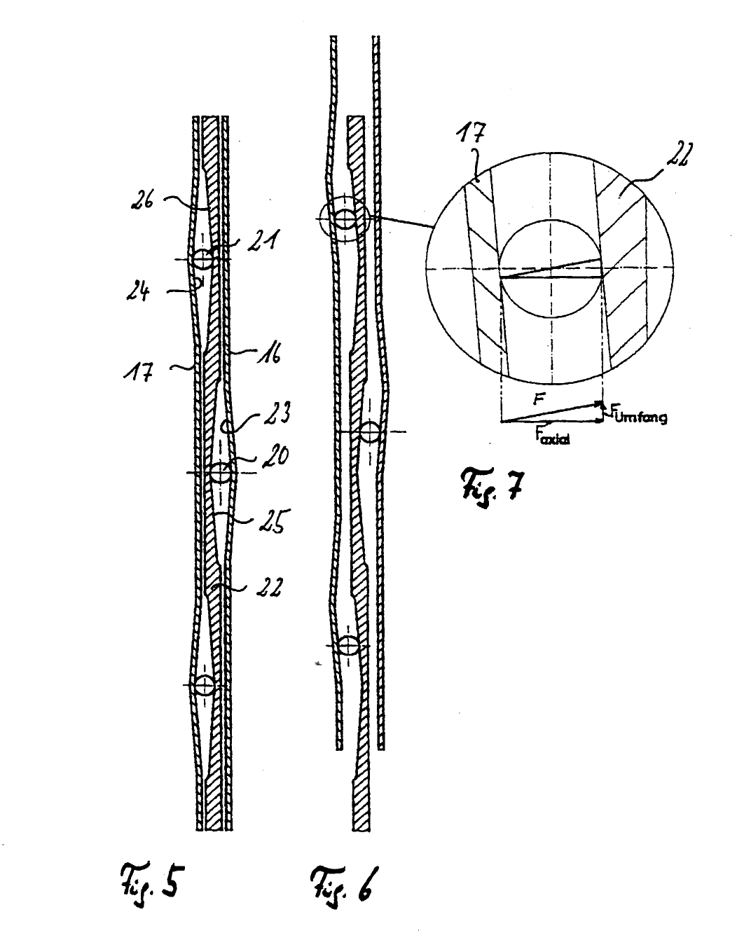

FIG. 5 shows a developed view through a torsional vibration damper illustrated in FIGS. 1 to 4 in the radial plane of the rolling bodies,

FIG. 6 shows an illustration of the developed view per FIG. 5 with the stopper rotated towards the sprung sheet,

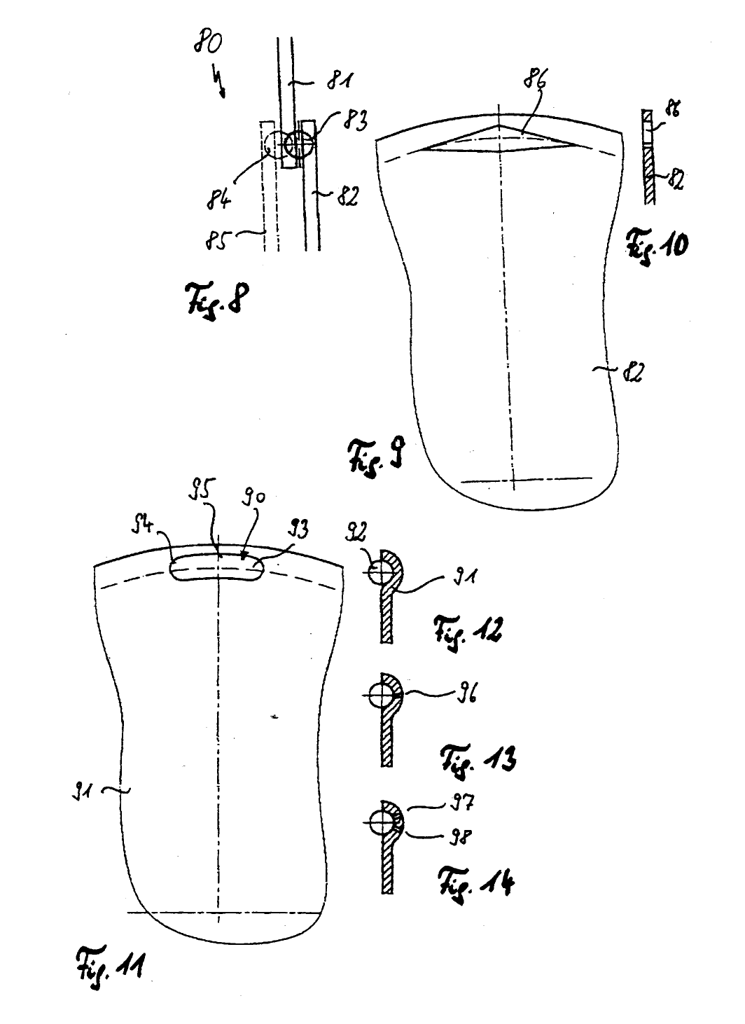

FIG. 7 shows a diagrammatic section from FIG. 6 showing the forces affecting the rolling body,

FIG. 8 is a schematic view of a rolling body guided in recesses in the sprung sheet and in the stopper,

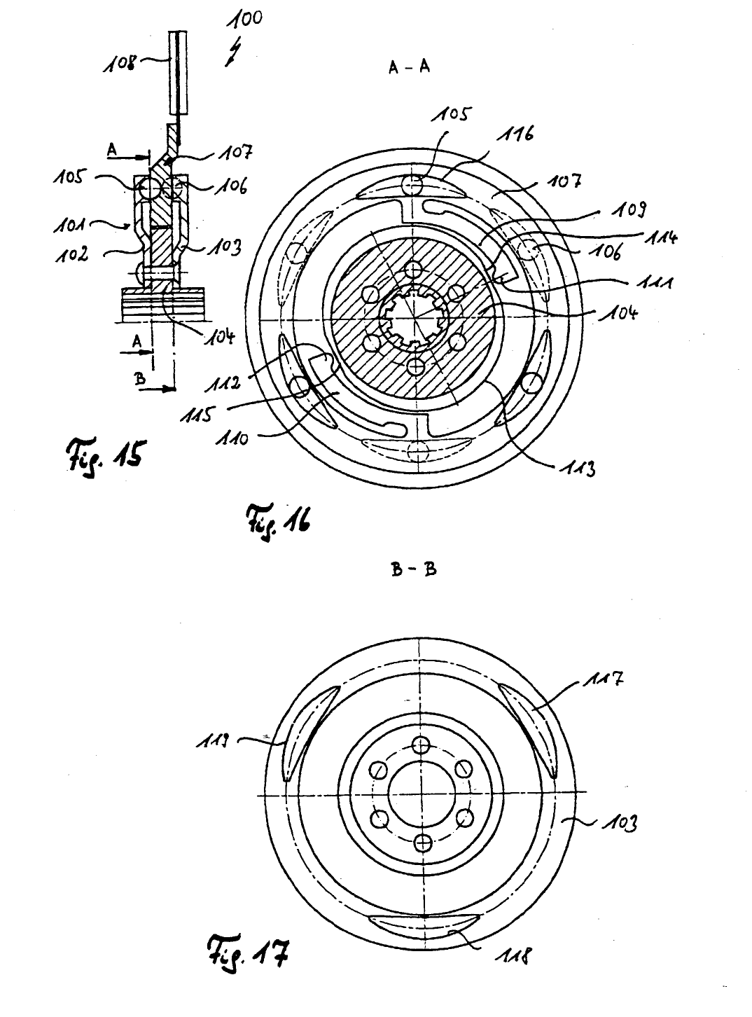

FIG. 9 is a schematic view of a sprung sheet with a rhomboidal opening,

FIG. 10 is a schematic view through the sprung sheet illustrated in FIG. 9,

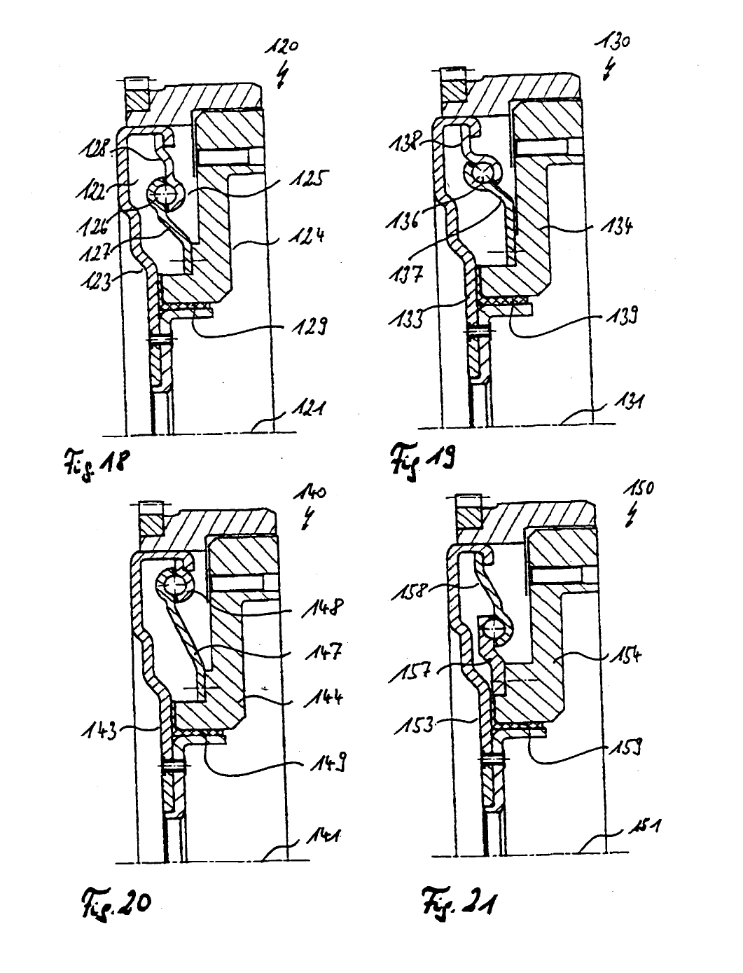

FIG. 11 is a schematic view of an alternative embodiment of a sprung sheet with dents designed as a bent lengthwise hole,

FIG. 12 is a schematic view through the sprung sheet illustrated in FIG. 11,

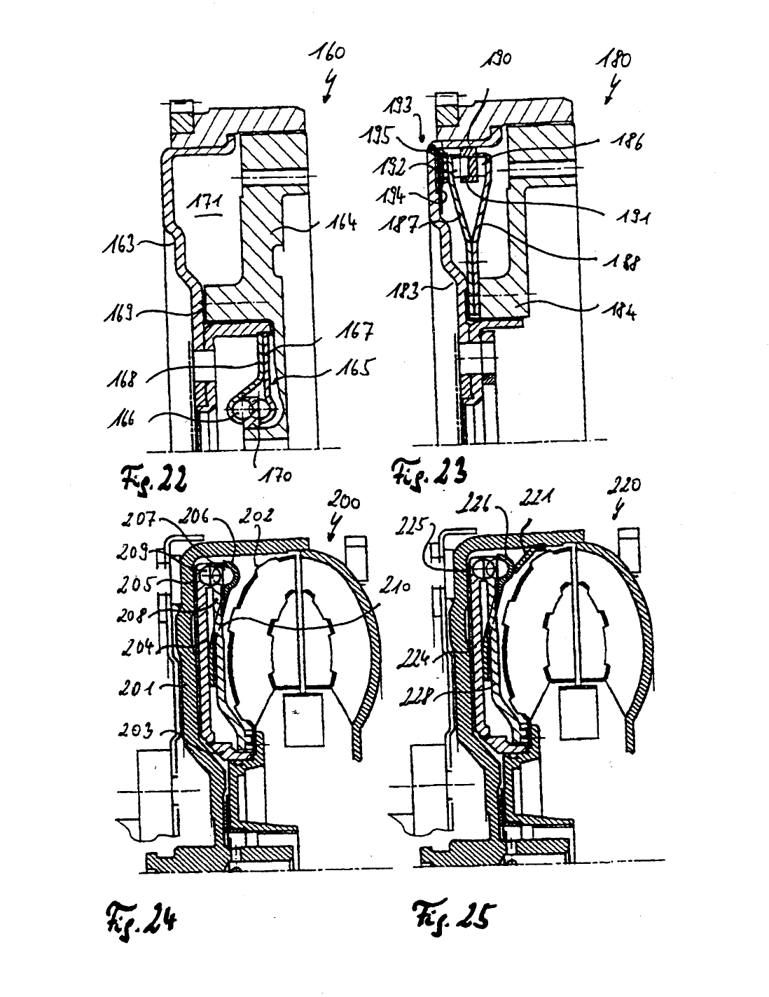

FIG. 13 is a view of the section illustrated in FIG. 12 with a bore,

FIG. 14 is a view of the section illustrated in FIG. 12 with two bores,

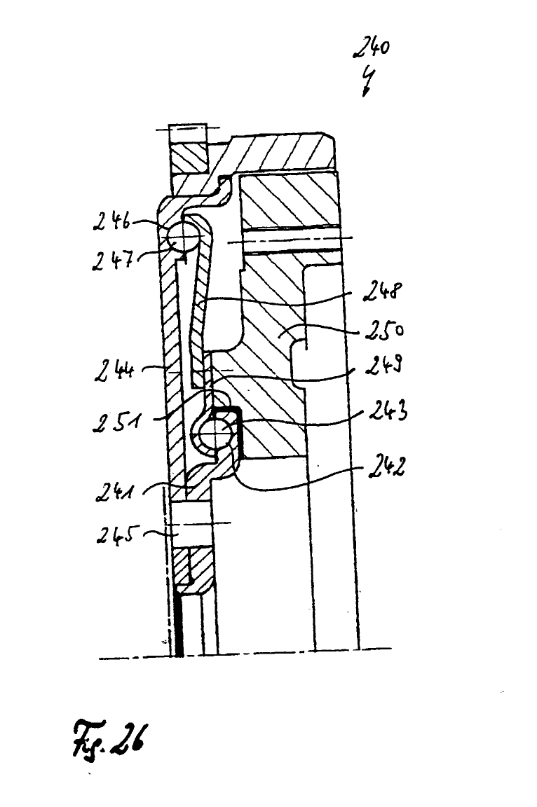

FIG. 15 is a schematic view of a spring element with a centrifugal-dependent damping device,

FIG. 16 is a section through the spring element illustrated in FIG. 15 along line A-A,

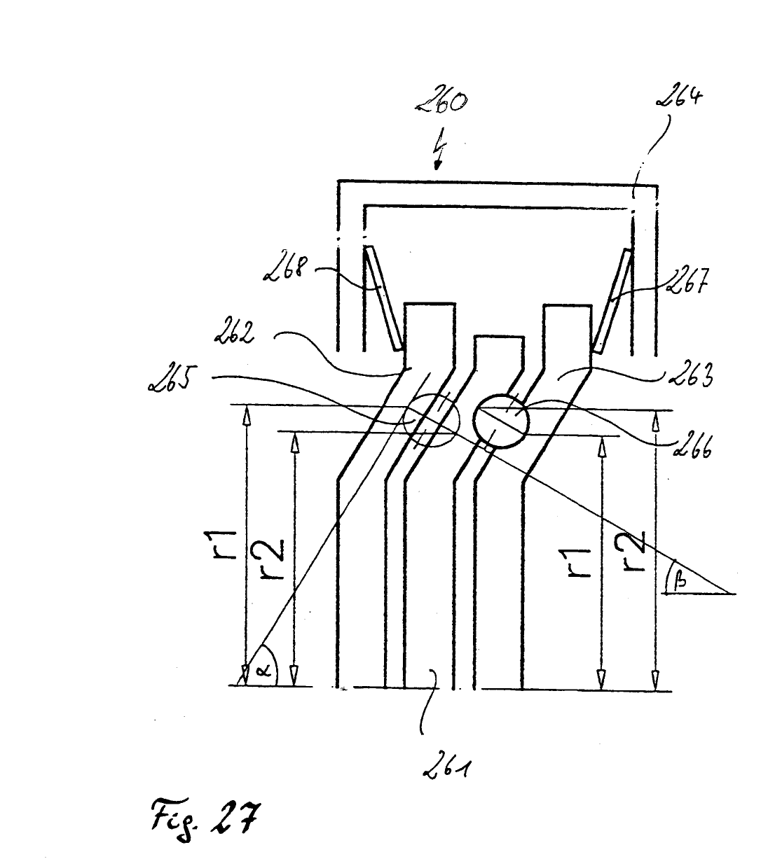

FIG. 17 is a section through the spring element illustrated in FIG. 15 along line B-B,

FIG. 18 is a schematic view through a torsional vibration damper with a spring element arranged radially outside a bearing of primary and secondary parts acting in an axial direction,

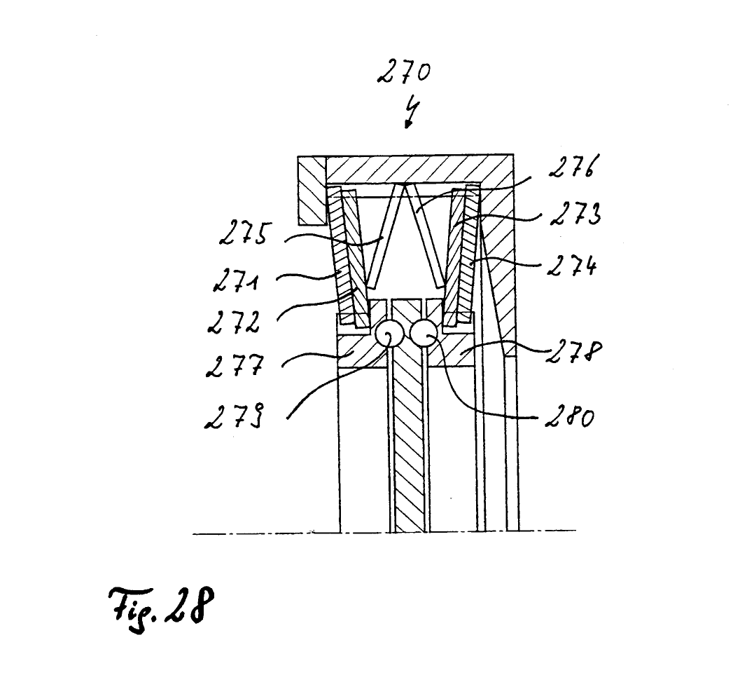

FIG. 19 is a schematic view through a torsional vibration damper as per FIG. 18 with a contact force acting at an acute angle to the axis between sprung sheet and rolling body,

FIG. 20 is a schematic view through a torsional vibration damper with rolling bodies lying radially outside far from the bearing,

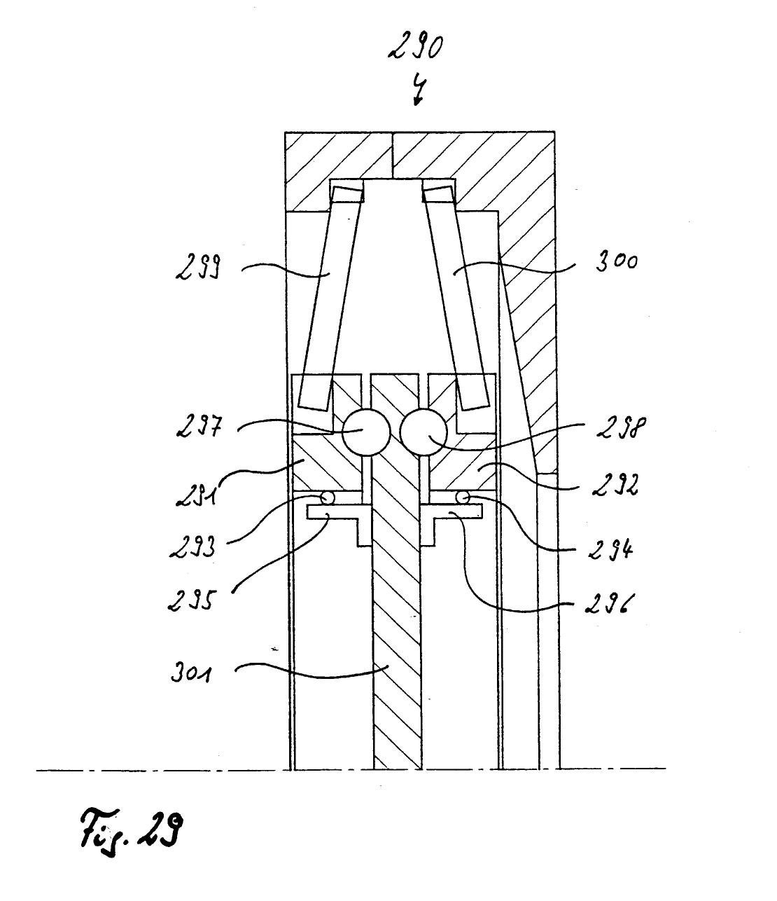

FIG. 21 is a schematic view through a torsional vibration damper with rolling bodies arranged radially outside the bearing,

FIG. 22 is a schematic view through a torsional vibration damper with rolling bodies arranged radially inside the bearing,

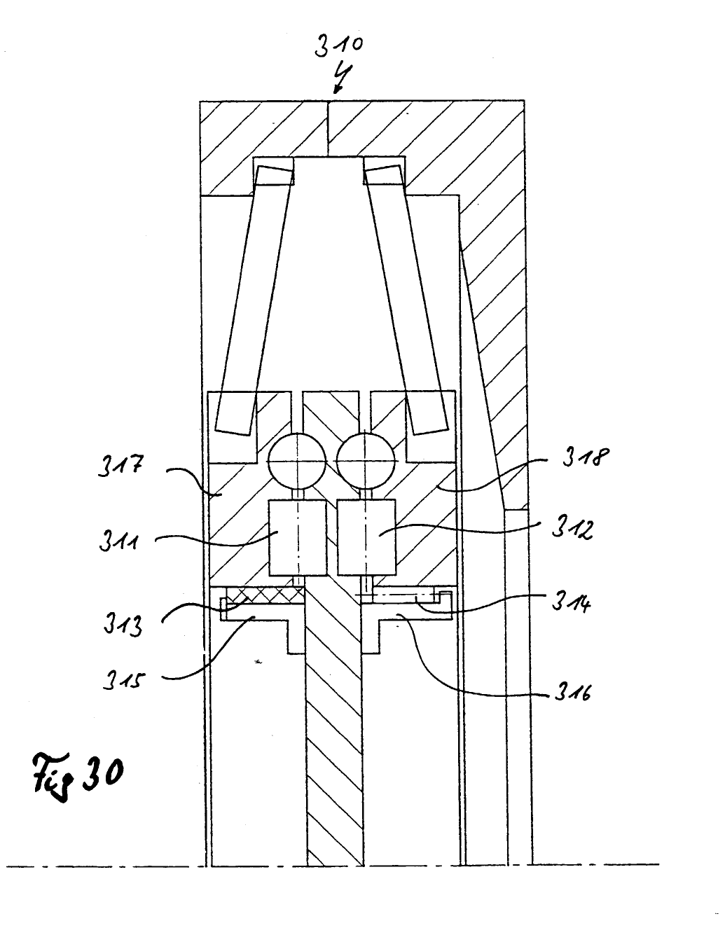

FIG. 23 is a schematic view through a torsional vibration damper with cylindrical rolling bodies,

FIG. 24 is a schematic view through a torque converter with inbuilt spring element according to the present invention,

FIG. 25 is a schematic view through a torque converter as per FIG. 24 with additional stopper,

FIG. 26 is a schematic view through a torsional vibration damper with rolling bodies arranged on two different radii,

FIG. 27 is a schematic view through a torsional vibration damper with two spring elements connected together torsionally rigidly which cooperate with a stopper via rolling bodies,

FIG. 28 is a schematic view through a torsional vibration damper with counteracting saucer springs,

FIG. 29 is a schematic view through a torsional vibration damper with discs mounted on spheres,

FIG. 30 is a schematic view of a torsional vibration damper with glide or needle bearings,

FIG. 31 is a section through the torsional vibration damper illustrated in FIG. 30,

FIG. 32 is a view through an alternative embodiment of a torsional vibration damper,

FIG. 33 is a view of a disc with S-shaped bent ball races,

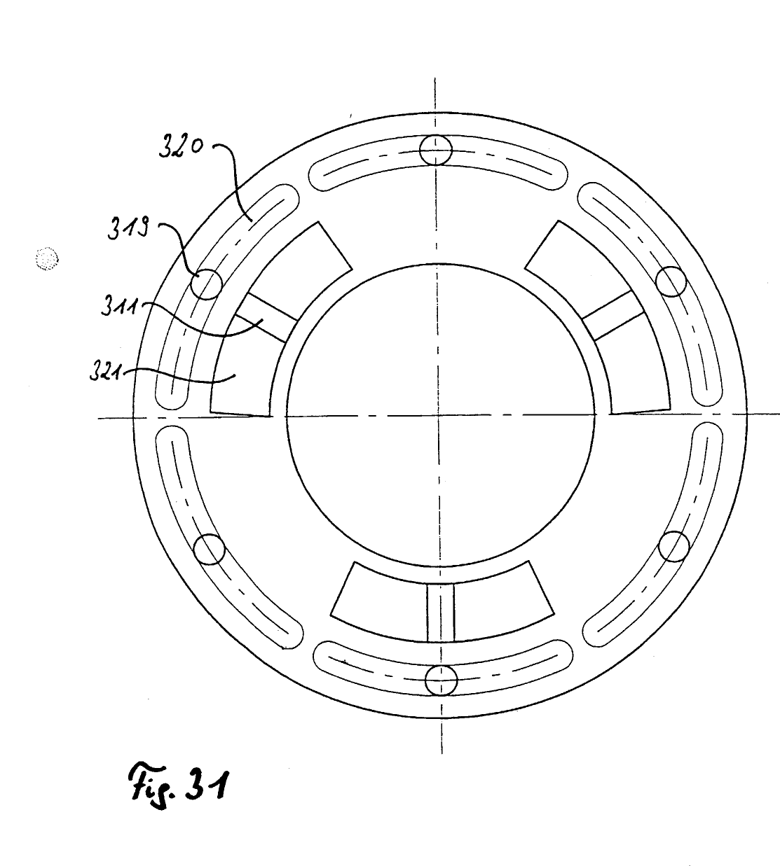

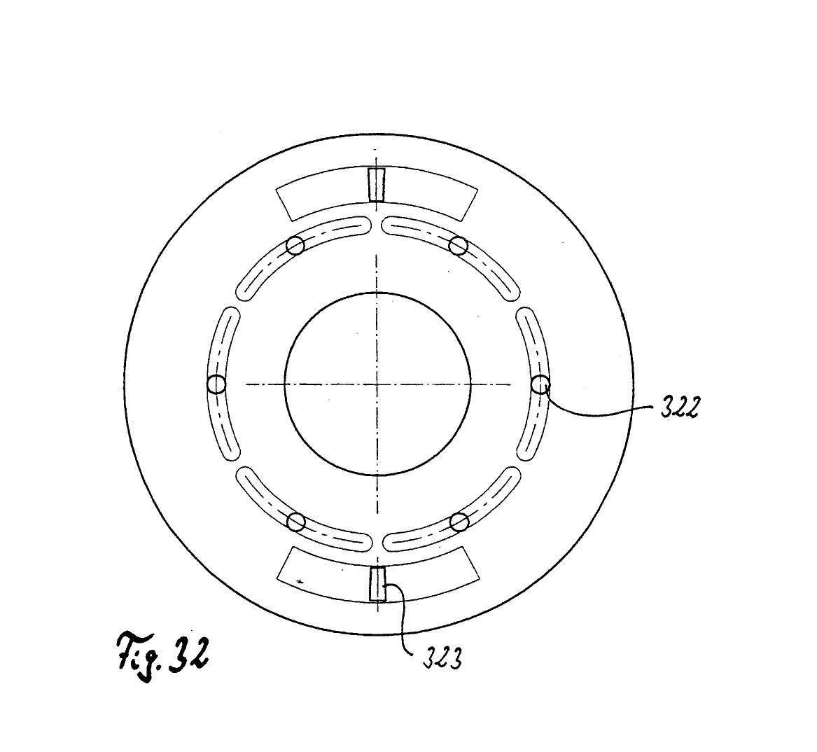

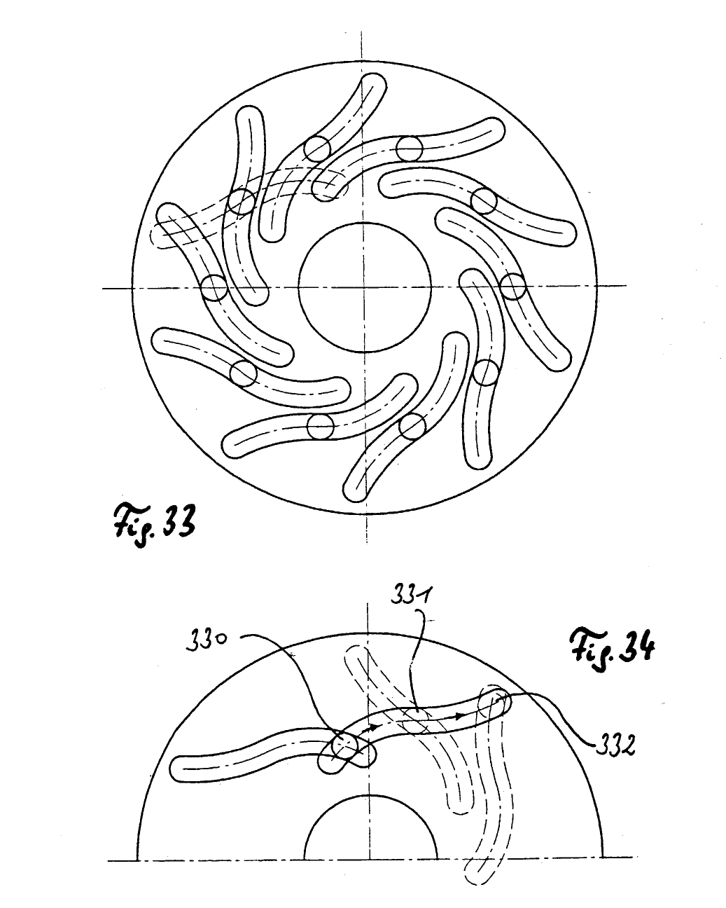

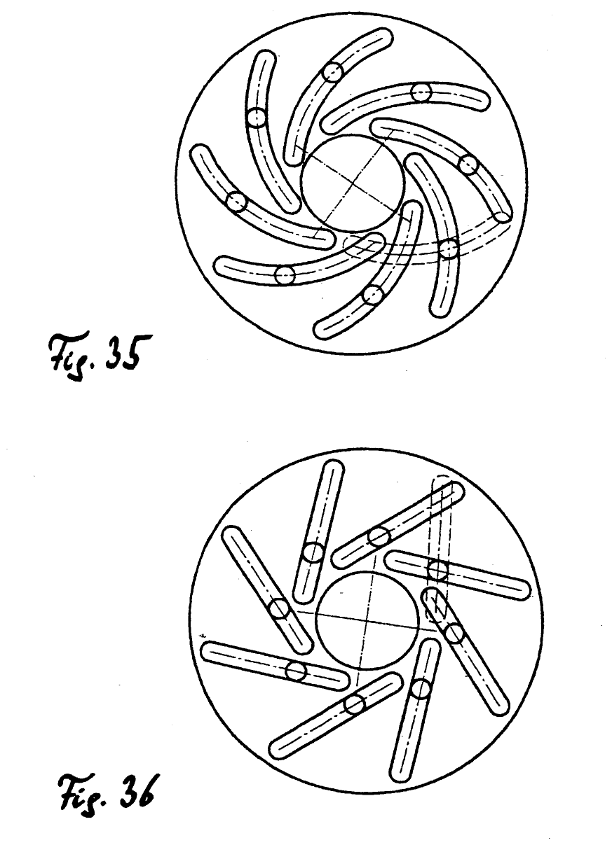

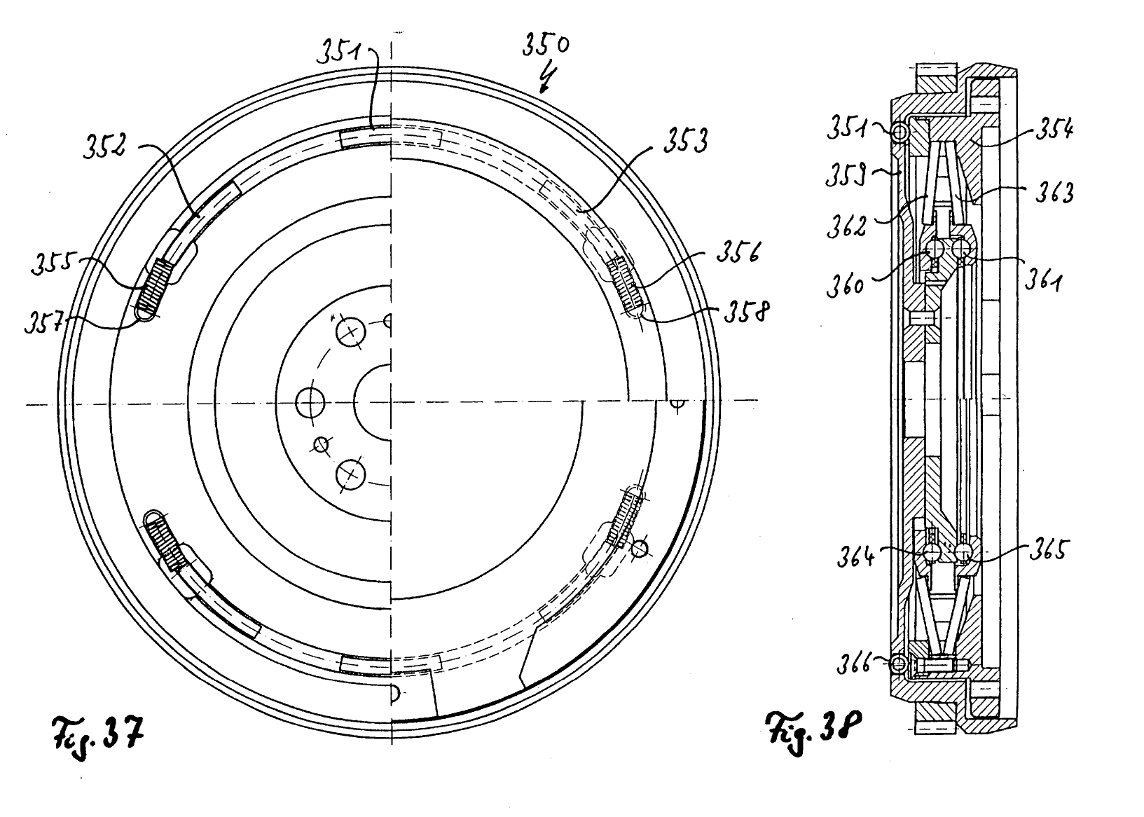

FIG. 34 is a view from FIG. 33,

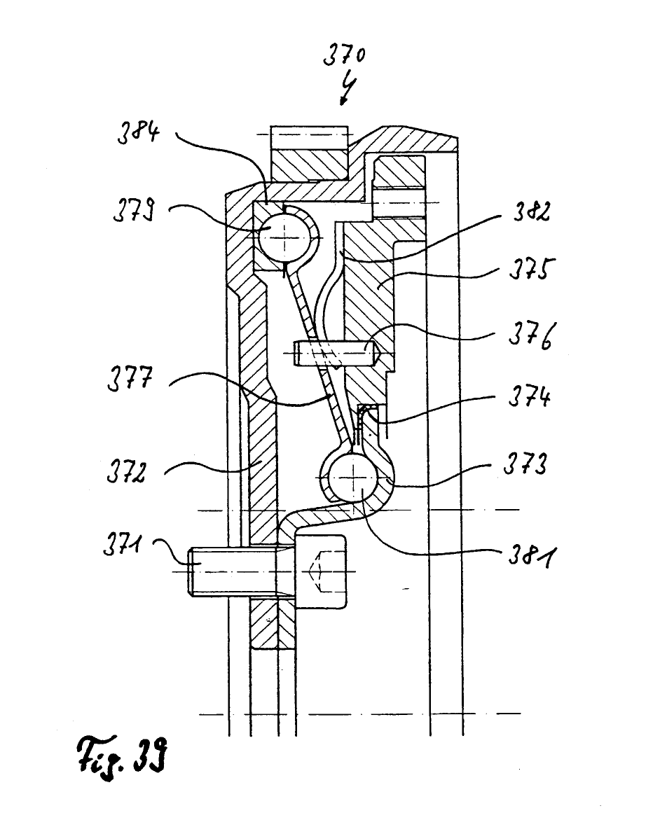

FIG. 35 is a disc with curved ball races,

FIG. 36 is a disc with straight ball races,

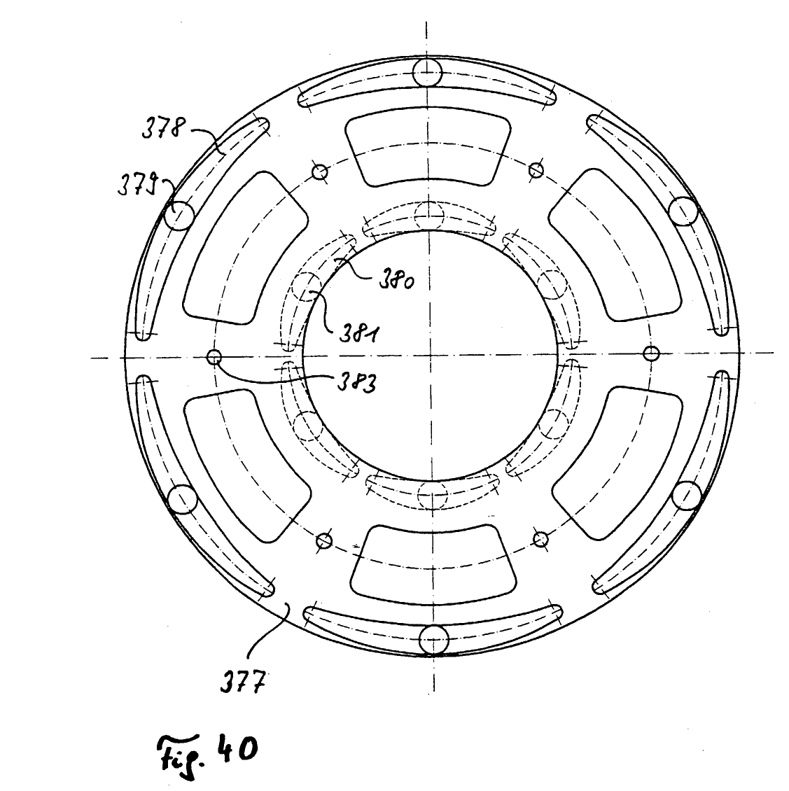

FIG. 37 is a section through a torsional vibration damper with modified torsional angle stopper,

FIG. 38 is a section through the torsional vibration damper shown in FIG. 37,

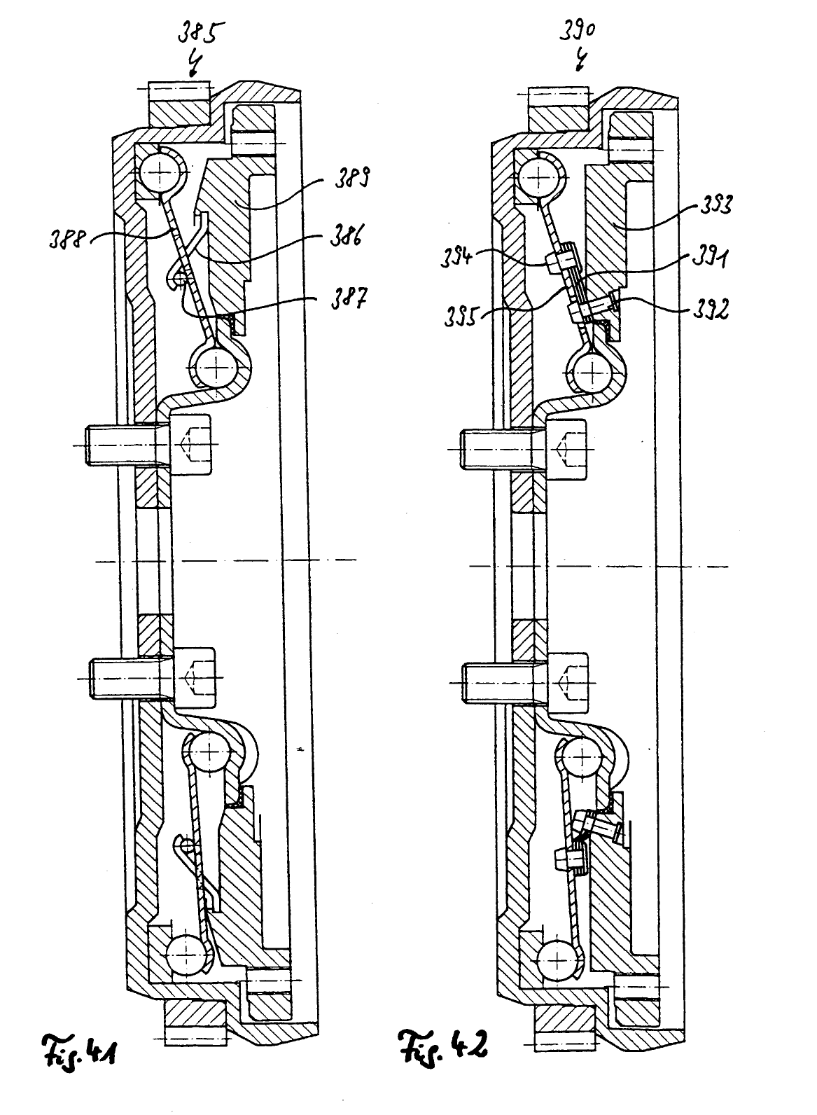

FIG. 39 is a section through a torsional vibration damper with a spring guided by a pin,

FIG. 40 is a view of the disc shown in FIG. 39,

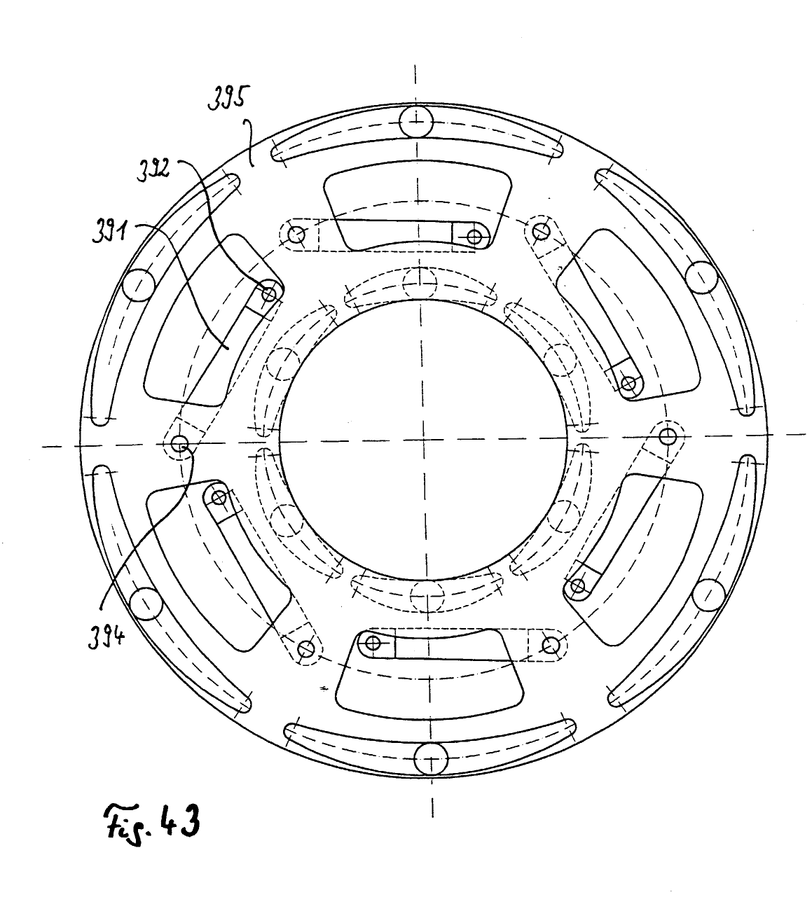

FIG. 41 is a schematic view through a torsional vibration damper with a prestressed spring,

FIG. 42 is a schematic view through a torsional vibration damper with a spring prestressed by means of a tangential sheet spring,

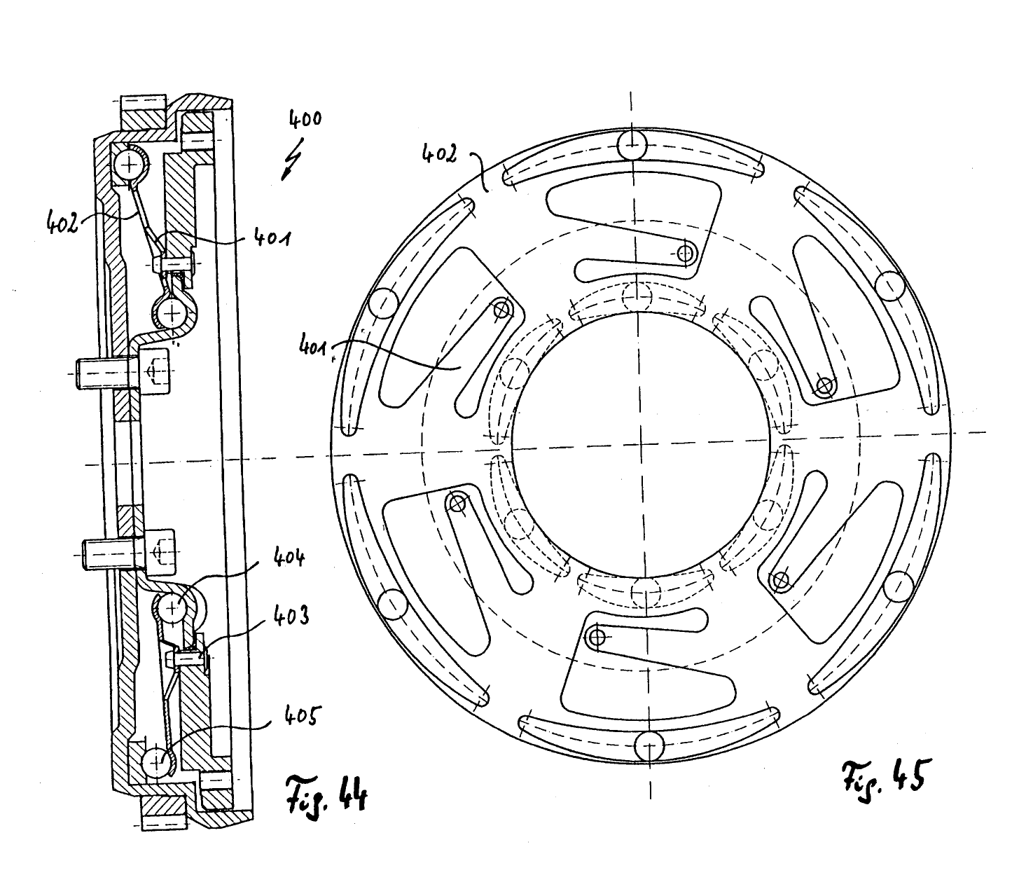

FIG. 43 is a view of the spring disc illustrated in FIG. 42,

FIG. 44 is a schematic view through a torsional vibration damper with a spring element integrated into the disc, and

FIG. 45 is a view of the spring disc illustrated in FIG. 44.

The torsional vibration damper 1 shown in FIG. 1 comprises a primary part 2, a secondary part 3 and an interposed spring element 4. The spring element 4 is positioned between the primary part 2 and the secondary part 3 such that a rotatory force applied to the primary part can be transferred via the spring element 4 to the secondary part 3.

The primary part 2 comprises an L-shaped flange part 5 which can be connected to a central axis. Provided in this L-shaped flange part 5 are bores 6, via which the flange part can be connected to a disc-shaped component 7. For this the disc-shaped component 7 has bores 8 on a radially inner end, which lie flush with the bores 6. In radial extension the disc-like component 7 has two axial graduations 9 and 10 and the radial outermost end of the disc-like component 7 is bent opposite to the graduations first in a direction parallel to the rotation axis and then a short piece runs radially outwards. Fixed in the vicinity of the outermost extension of the disc-like component 7 is an additional mass 11 on the disc-like component 7. Finally the flywheel ring gear 12 is attached to this additional mass 11.

Provided radially inside the additional mass 11 and offset axially to the disc-shaped component 7 is a disc-like component 13 Z-shaped in cross-section as secondary part 3. This Z-shaped component 13 has in its radial outside region a bore 14 for connecting the secondary part 3 to a coupling device (not illustrated). Fixed to the radial inner end of the Z-shaped component 13 is the spring element 4 on a radially extending side 15 opposite the disc-shaped component 7.

The spring element 4 comprises two sprung sheets adjacent in an axial direction, which are designed as saucer springs 16, 17. The radial inner end of these saucer springs 16, 17 is connected to itself and to the secondary part 3. The radial outer end of the saucer springs 16, 17 each has a circumferential groove 18, 19 which acts as guide for spherical rolling bodies 20, 21. The grooves 18, 19 are open to one another and the sprung sheets 16, 17 press the rolling bodies 20, 21 against an interposed stopper 22.

The stopper 22 is fixed flange-like in the outer region of the disc-shaped part 7 on the primary part and extends from there radially inwards.

The spring element 4 positioned between primary part 2 and secondary part 3 thus has a first region 23, 24 between the sprung sheets 16, 17 and the rolling bodies 20, 21 and a second region 25, 26, in which the rolling bodies 20, 21 cooperate with the stopper 22.

The region 25, 26 on the stopper 22 is designed as a guide. In the present case a groove limited in the peripheral direction in the stopper 22 acts as a guide for the spherical rolling bodies 20 or 21.

In the abovedescribed embodiment the described guides of the rolling bodies 20 or 21 have a bearing function which enables the secondary part 3 to bear on the primary part 2 and whereby the secondary part does not at all have to be mounted on a central axis or a flange piece.

FIG. 2 shows that in addition to bearing in the region of the rolling bodies another bearing can be provided between primary part and secondary part. With the torsional vibration damper 30 illustrated in FIG. 2 a bearing 33 is therefore provided between the primary part 31 and the secondary part 32. To this end a Z-shaped component 35 is fixed on the disc-shaped component 34 of the primary part 31. This Z-shaped component 35 has a peripheral surface 37 concentric to the axis of rotation 36, on which an L-shaped bearing shell 38 rests. This L-shaped bearing shell 38 has a part 39 extending axially, positioned between the Z-shaped component 35 and the secondary part 33. A radially extending part 40 of the L-shaped bearing shell 38 lies between the disc-shaped component 34 and the spring element 41. The bearing shell thus forms a glide bearing acting axially and radially between the primary part 31 and the secondary part 32.

In the torsional vibration damper 30 illustrated in FIG. 2 both saucer springs 42 and 43 of the spring element 41 are bent such that they are adjacent to one another in a radial inner region and diverge in a V-shape in a radial outer region. In this embodiment the stopper 44 lies flush with that area of the saucer springs, in which they are adjacent to one another plane. The result of this initially is that both saucer springs 42 and 43 act with the same force on the stopper 44. The bead 45 indicated in FIG. 2 on the saucer spring 43 shows how this contact force can be varied in a simple manner. Understandably also one or more beads can be attached in the other spring 42 or the strength of the spring can be reduced selectively to influence the resilient characteristic. A disc 46 extending inwards radially from the outer edge of the disc-shaped component 34 acts as a seal against penetration of dust from the coupling to the region of the rolling bodies and facilitates optionally keeping a lubricant in the region of the rolling bodies.

FIG. 3 illustrates a torsional vibration damper 50 wherein a damping device 53 is positioned between the primary part 51 and the spring element 52. This damping device 53 comprises a saucer spring 54, whose radial inner end is fixed to the primary part 51 and whose radial outer end has a friction coating 55 which is pressed by the saucer spring 54 against the spring element 52. Instead of a saucer spring a spinning spring can be used for this because of its more favourable resilient characteristic.

Also provided with the torsional vibration damper 50 is a U-shaped bearing shell 56, between whose arms the radial inner end of the spring element 52 and the radial inner end of the secondary part 57 lie. The outside of both arms of the U-shaped bearing shell 56 border on the disc-shaped component 58 of the primary part 51 and on a holding flange 59. The spring element 52 is thus held in both axial directions together with the secondary part 57 in a defined position relative to the primary part 51.

Both the illustrated damping device 53 and the U-shaped bearing shell 56 can be used independently of one another for other variant embodiments of torsional vibration dampers.

With the torsional vibration damper 50 illustrated in FIG. 3 the guide of the rolling bodies 60, 61 is designed such that with higher speeds on the torsional vibration damper under influence of the centrifugal force inside the guide within a defined area the rolling bodies can wander outwards. For this both on the springs 62, 63 and on the stopper 64 the guide groove is provided with a special curved form which ensures that the rolling bodies 60 and 61 are guided at different radial distances from the axis of rotation 65 depending on the speed.

Due to speed-dependent variation of the guide path of the rolling bodies a varying axial wandering of the sprung sheets 62 and 63 depending on speed can also be achieved. This leads to the fact that the force between the friction device 53 and the sprung sheet 63 is varied depending on the speed.

The design of the guide paths of the rolling bodies thus allows influencing of a wide range of characteristic lines of the torsional vibration damper and thus influencing of different effective characteristics.

A further example of a torsional vibration damper 70 is shown in FIG. 4. This torsional vibration damper is substantially similarly constructed to the torsional vibration damper 30 shown in FIG. 2. Two saucer springs 71 and 72, which are arranged concentrically to the axis of rotation 73 of the torsional vibration damper 70 and act on a friction disc 74, are provided as damping agent in this torsional vibration damper 70. This friction disc 74 acts in the illustrated embodiment in an axial direction on the sprung sheet 75, to create damping. The effective direction of the friction disc 74 on the sprung sheet 75 of the spring element 76 can be varied by designing the contact surface between friction disc 74 and spring element 76, and also a guide of the rolling body, dependent on speed and mentioned hereinabove, can lead to a variation in the damping characteristics.

In place of the concentric saucer springs 71 and 72 several springs arranged on a circular line can also provide pressure of the friction disc 74 on the spring element 76.

The previously described structure of the torsional vibration damper shown in FIGS. 1 to 4 illustrates only a special roller bearing between primary and secondary part and cooperation of this bearing with a damping device. According to the present invention however in a relative movement between primary and secondary part the sprung sheet is bent. This can be caused by ramps which effectively bend the spring element or a sprung sheet when the primary part is rotated relative to the secondary part.

FIGS. 5 and 6 illustrate how through appropriate development of the regions between sprung sheet and rolling body or rolling body and stopper the sprung sheets 16 and 17 can be pressed out, depending on the torsional angle. The rolling body 20 is clamped in between the first region 23 of the sprung sheet 16 and the second region 25 of the stopper 22. Here, depending on embodiment, any initial stress can be set.

The body 21 is accordingly arranged between the first region 24 of the sprung sheet 17 and the second region 26 of the stopper 22.

As soon as torque acts between the primary part and the secondary part, this results in the sprung sheets 16 and 17 moving relative to the stopper 22 and the rolling bodies pressing the sprung sheets 16 and 17 apart as a result of the curved regions. In FIGS. 5 and 6 the curved paths of the second regions are designed such that the sprung sheets 16 and 17 are pressed apart both when there is torsion between the sprung sheets 16, 17 and the stopper 22 in one direction and when there is torsion in the opposite direction.

The forces occurring on the rolling body 21 are illustrated diagrammatically in FIG. 7. The force F acting between the stopper 22 and the sprung sheet 17 has a power component F_{periphery} working in a peripheral direction and a power component Fₐₓᵢₐₗ working in an axial direction. The forces therefore exert a restoring force, which returns the spring element into the zero position shown in FIG. 5.

FIGS. 5 and 6 demonstrate how a special guide path for the rolling bodies 20, 21 can be created by specially developing the spring elements 16 and 17 in the peripheral direction and by a stopper strength varying in the peripheral direction. Understandably, a guide path for the rolling bodies 20, 21 can also be created by varying the strength of the spring elements 16 and 17 in the peripheral direction and by specially developing the stopper.

In contrast to this FIGS. 8 to 10 show that a corresponding curved path can also be created via a special opening in the sprung sheet. In the embodiment 80 shown in FIG. 8 a recess, into which the rolling body 83 extends, is provided both in the stopper 81 and in the sprung sheet 82. The rolling body 84 extends offset in a peripheral direction on the other side of the stopper 81 into a recess in the stopper 81 and another recess in the sprung sheet 85.

An example of such a recess 86 is illustrated in FIG. 9 on the sprung sheet 82. The overall view from FIGS. 9 and 10 shows that the approximate rhomboidal recess 86 corresponds to a bent rhomboid in a peripheral direction. The maximum cross-section of the opening is however smaller than the cross-section of the rolling body 83, so that the rolling body 83 is guided by the edges of the recess 86. During a relative movement between sprung sheet 82 and stopper 81 this results in the rolling body 83 moving into the region of the opening 86 tapering off at an acute angle and presses the stopper 81 and the sprung sheet 82 apart from one another.

A similar function is to be gained by the grooved guide 90 shown in FIGS. 11 to 14. A groove bent in a peripheral direction, which has the shape of a bent longitudinal hole in the plan view, extends on the sprung sheet 91. This groove 90 has a concave form matching the radius of a rolling body 92. The depth of the groove in the edge regions 93 and 94 is less than in the middle region 95, and effects a separating movement of sprung sheet and stopper in the edge region. In the middle region 95 the depth of the groove is constant over a defined peripheral angled area, so that the system exerts increased force on the sprung sheet 91 as soon as a special peripheral angle is exceeded.

A corresponding longitudinal hole can be provided in place of the grooved guide 90 of the longitudinal dent 90.

Contaminant particles, which penetrate into the region between the sprung sheet 91 and the rolling bodies 92 or into the region between the rolling bodies 92 and the stopper (not illustrated), can leave the region via the opening 96 shown in FIG. 13 or the openings 97 and 98 shown in FIG. 14.

FIGS. 15, 16 and 17 show an advantageous embodiment of a torsional vibration damper 100 with a damping device dependent on speed.

The secondary side 101 can be connected to a shaft and has two opposing disc-like components 102 and 103, which are riveted to an interposed flange part 104. In their radial outer region the disc-shaped components 102 and 103 exhibit guides for rolling bodies 105 and 106. These guides press the rolling bodies against a stopper 107, which acts as primary part of the torsional vibration damper 100. This stopper 107 is connected to a coupling device 108.

Due to a special form of guides 116 in the stopper 107 during relative movement between primary part 101 and secondary part 107 the rolling bodies 105 and 106 are forced in opposing axial directions and through this the disc-like components 102 and 103 acting as springs are forced apart. The resulting forces can be adjusted by selecting the guides between the rolling bodies 105, 106 and the stopper 107 or the rolling bodies 105, 106 and the disc-shaped components 102 and 103.

Arranged in a radial direction between the stopper 107 and the flange-like part 104 are arms 109 and 110 extending in a peripheral direction, whose noses 111 or 112 extending inwardly in a radial direction can cooperate with the peripheral contour 113 of the flange-like part 104. The peripheral contour 113 of the flange-like part 104 has flattened areas 114, 115 in which the noses 111 and 112 do not contact the flange-like part 104, resulting in a limited free angle. In the remaining areas noses 111 and 112 rub on the peripheral contour 113 and thus cause damping between primary part 101 and secondary part 107. Due to choice of the radius of the peripheral contour 113 the friction characteristic can be influenced.

It is easily seen that at greater speeds of the secondary part 107 a centrifugal force acts on the arms 109 and 110 which reduces or even eliminates friction on the peripheral contour 113.

The guide contours 116 arranged on the stopper 107 in an equilateral triangle correspond in the present case to the guide contours 117, 118, 119 on the disc-shaped parts 102 and 103. In that the guide contours match one another on the first and second region, the spherical rolling bodies 105, 106 can roll away without slipping.

But it is also possible to provide different guide contours on the first and second region in order to modify the characteristic lines of the spring system.

FIGS. 18 to 21 illustrate torsional vibration dampers 120, 130, 140 and 150, in which the rolling bodies are positioned at various radial distance from the axis of rotation 121, 131, 141, 151.

In FIG. 18 the spring element 125 is arranged radially and approximately in the centre in a space 122 between the primary part 123 and the secondary part 124. Two saucer springs 127 and 128 acting on the rolling body 126 thus generate an axial force which presses on the rolling body 126 in an axial direction and with identical force against the axial bearing. This defines friction on the axial bearing.

In the embodiment illustrated in FIG. 19 the effective axis of the forces acting on the rolling body 136 is at an acute angle to the axis of rotation 131 and this is achieved by the angled form of the saucer springs 137 and 138. The figure shows that forces acting on the rolling body 136 in the extreme case can even lie on a radial line. This results in reduction of the forces acting in an axial direction between primary part 133 and secondary part 134. The resulting radial force components cancel each other out due to the concentric arrangement of the rolling bodies 136 and the component lying in an axial direction defines the friction on the axial bearing.

The torsional vibration damper 140 shown in FIG. 20 has a saucer sprung sheet 148 with extremely short radial extension fixed on the primary side 143 and a saucer spring 147 with relatively large radial extension on the secondary side 144. The greatest proportion of the resilience is taken over by the sprung sheet 147 fixed on the secondary side.

The reverse situation is shown in FIG. 21 on the torsional vibration damper 150. Here the sprung sheet 157 attached on the secondary side 154 is designed almost rigid and the spring function is substantially taken over by the sprung sheet 158 fixed on the primary side 153.

In all four embodiments an L-shaped bearing shell 129, 139, 149, 159 provides the bearing of the primary part relative to the secondary part.

FIG. 22 illustrates a torsional vibration damper 160 with an L-shaped bearing shell 169 as bearing between the primary part 163 and the secondary part 164. In this embodiment the spring element 165 is positioned radially inside the bearing shell 169. Two sprung sheets 167 and 168 act on rolling body 166 and cooperate with a flange-like part 170 on the secondary part 164. This results in a free space 171 radial outside the L-shaped bearing shell 169 between the primary part 163 and the secondary part 164, in which a damping device or another spring element for example can be arranged.

An embodiment of a torsional vibration damper 180 with cylinder-shaped rolling bodies 186 is illustrated in FIG. 23. The cylindrical rolling bodies 186 run in grooved guides 191 arranged in a peripheral direction on a lateral face of a stopper 190. Here rolling bodies 186, 192 are pressed by the sprung sheets 187, 188 onto the stopper 190 offset to one another from one side respectively. The sprung sheets 187 and 188 are connected together at their radial inner end and to the secondary part 184. The stopper 190 is connected to the primary part 183 which sits on the drive shaft (not illustrated) . A friction device 193 acts between the primary part 183 and the sprung sheet 187. This friction device 193 comprises a saucer spring 194 placed concentrically to the axis of rotation 181, and a friction coating 195 which is pressed by the saucer spring 194 against the sprung sheet 187.

FIG. 24 illustrates a torque converter 200 known per se. Here the force of the motor shaft is transferred to the housing 201 and to the disc-like component 204 via the hydraulic blade arrangement via the counterblade 202 and the piston element 203. When the torque converter is closed there is sufficient pressure acting on the disc-shaped component 204, so that the component 204 is pressed onto a friction coating 205 on the housing 201. The disc-like component 204 is then connected to the primary side via the friction coating 205. In this respect in this embodiment, different to other embodiments, the stopper is provided on the secondary side and the spring elements on the primary side.

Fixed to the disc-shaped component 204 is a sprung sheet 206 which has a guide for a spherical rolling body 207 at its radial outer end. This rolling body 207 is pressed by the sprung sheet 206 against the stopper 208 and on the opposite side of the stopper 208 a spherical rolling body 209 is held between the disc-shaped component 204 and the stopper 208. So that the rolling bodies 207 and 209 can be pressed and clamped from two sides against the stopper 208, a window 210 is provided in the stopper, through which the sprung sheet 206 extends. The window 210 allows limited rotational movement between disc-shaped component 204 and sprung sheet 206 on the one side and the stopper 208 on the other. As a result of the design of the guides for the rolling bodies 207 and 209 this rotational motion leads to a disc-shaped component 204 and sprung sheet 206 moving apart. The rolling bodies 207 and 209 are held for example as shown in FIGS. 5 and 6, and with rotation of the stopper 208 relative to the sprung sheet 206 and to the disc-like component 204 this leads to counterrotating axial motion of the latter components.

The contact force of the entire spring system on the housing of the torque converter can be reinforced, as for the torque converter 220 shown in FIG. 25, by an additional saucer spring 221 or a stopper. With torsion of the sprung sheet 226 and of the disc-like component 224 relative to the stopper 228 the entire spring arrangement in FIG. 25 is pressed to the left against the friction coating 225 and to the right against the saucer spring 221. The effect of this is that from a certain torsional angle, that is, from a certain wandering of the sprung sheet 226, the saucer spring 221 presses the spring arrangement against the friction coating 225. This motion of the components 224 and 226 results in the disc-like component 224 being pressed more strongly against the friction coating 225, so that as compared to the prior art only minimal hydraulic pressure is required to close the torque converters.

FIG. 26 illustrates another option for arranging the spring element according to the present invention in a torsional vibration damper. This construction is characterised by particularly small axial expansion of the spring damper.

The torsional vibration damper 240 shown in FIG. 26 has on the primary side an essentially Z-shaped flange part 241, on whose radial outer lateral face a guide 242 for rolling body 243 is provided. A disc-shaped component 244 is attached to the Z-shaped component 241 by means of a bolt set in the bore 245 (not illustrated). This disc-shaped component 244 has greater radial extension than the Z-shaped component 241 and likewise has on its radial outer end a guide 246 for a rolling body 247.

In contrast the guides 246 and 242 for the rolling bodies 243 and 247 have concave forming for holding the rolling bodies. The rolling body 247 is held on the side opposite the guide 246 by a sprung sheet 248 and the rolling body 243 is held on the side opposite the guide 242 by the retaining spring 249. The sprung sheet 248 and the retaining spring 249 are connected to one another and fixed to a disc-like component 250 serving as a secondary part.

The disc-shaped component 250 is mounted via an L-shaped bearing shell 251 axially and radially on the Z-shaped part 241. The bearing is located in the immediate vicinity of the guide 242 and the rolling bodies 243 and 247 are arranged radially inside or radial outside the radial bearing between primary part and secondary part.

The guides 242 and 246 as well as the springs 248 and 249 provided on the opposite guides are, as illustrated in FIGS. 5 and 6, designed such that when there is torsion on the primary parts against the secondary part a bending force acts on the retaining spring 249 and in particular on the sprung sheet 248.

The configuration of the guides shown in FIGS. 5 and 6 can also be provided only on the radial outer rolling bodies, because in the described embodiment there is more space provided in this region for bending of the sprung sheet 248.

FIG. 27 shows a torsional vibration damper 260, in which a first centrifugal mass 261 is positioned between two discs 262, 263. Both discs 262 and 263 are connected to one another torsionally rigidly via the bridge 264 and rolling bodies 265 or 266 are arranged between the first centrifugal mass 261 and each of the discs 262 or 263. These rolling bodies are balls in the present embodiment.

The bridge 264 connects the discs 262 and 263 by interposing springs 267, 268, which press the discs 262 and 263 against the roller bearings 265 and 266 and thus against the first centrifugal mass 261. The torsional rigidity of both discs 262 and 263 is achieved by gearing on the discs 262, 263, the springs 267, 268 and/or on the contact surface of the springs 267, 268 on the bridge 264. However, other preferably positively locking connections are also possible here.

The contact surfaces between the discs 262 and 263 and the rolling bodies 265, 266 or the rolling bodies 265, 266 and the first centrifugal mass are at an acute angle to the axis of rotation of the torsional vibration damper and thus the connecting axle between the contact points of the rolling bodies likewise is at an acute angle β to the axis of rotation of the vibration damper.

The contact areas between the rolling bodies and the first centrifugal mass or the discs 262, 263 are designed as illustrated in FIGS. 5 and 6. This causes the discs 262 and 263 to move apart if the first centrifugal mass 261 rotates against the assembly comprising the discs 262, 263, the springs 267, 268 and the bridge 264. The springs 267, 268 are tensed in the process.

A translation ratio results for each ball on account of the diagonal arranging of the contact points between the balls and the discs. If the disc 261 is considered as a drive, the disc 262 would want to rotate more slowly according to the translation R1/R2 and the disc 263 rotate faster. Due to the rigid connection between the discs 262 and 263 this procedure is hampered and subsequently creates forced slippage, which can then be used as damping. The damping can be adapted independently of the torsional angle by varying the respective contact points of each ball.

FIG. 28 illustrates a torsional vibration damper 270 corresponding in construction substantially to the torsional vibration damper shown in FIG. 27. The arrangement of the parallel acting saucer springs 271, 272 and 273, 274 as well as the counteractive saucer springs 275, 276 enables precise setting of special characteristic spring lines, leading to defined damping. The discs 277 and 278 are positioned by the rolling bodies 279, 280. This means that mounting of the discs 277 and 278 can be dispensed with.

The torsional vibration damper 290 illustrated in FIG. 29 has two discs 291 and 292, which are mounted radially via rolling bodies 293 and 294 on supports 295, 296. In this embodiment balls are shown as rolling bodies. Because at this point it is mainly radial forces which can be absorbed, rollers or needle bearings can also be used. The balls 297 and 298 serve to position the discs 291 and 292 and the saucer springs 299, 300 act as energy accumulators.

Additional damping devices can be arranged radially inside or radially outside the balls 297 and 298. These preferably comprise rollers (not illustrated), acting between the discs 291 and 292 and the middle disc 301. To vary the damping effect depending on the torsional angle, these rollers run in guide paths which cause increased pressure and thus increased damping when there is increased torsional angle between the discs 291 and 292 and the middle part 301.

An embodiment of such a torsional vibration damper 310 with radial inner damper rollers 311 and 312 is illustrated in FIG. 30. In this embodiment a slide bearing 313 or a bearing with needles 314 is additionally provided between the discs 317 and 318 and the supports 315 and 316.

FIG. 31 illustrates a diagrammatic section through the embodiment shown in FIG. 30. This shows the arrangement of the balls 319 on paths 320 and arrangement of the rollers 311 on paths 321. Whereas the paths 320 are essentially designed for the task of positioning, the paths 321 act as damping and are formed accordingly.

The arrangement of radial inner balls 322, which together with the discs and the saucer springs take on the function of a spring accumulator, and radial outer rollers 323, which take on the function of the damping work, is shown in FIG. 32. The remaining structure corresponds to the embodiment shown in FIGS. 30 and 31.

Whereas in FIGS. 31 and 32 concentric curved roll path sections are provided for the balls between the first centrifugal mass and the discs of the second centrifugal mass, FIG. 33 shows that the ball races can also serve to guide the balls in a radial direction. In both embodiments the guide paths function as a cage. The embodiment shown in FIG. 33 results, however, in minimal friction (pure rolling away) when rolling away occurs between the discs and the balls in a peripheral direction, whereas when the balls move in a radial direction there is increased friction due to forced slippage. Additionally, radial guiding of the balls enables all the more balls to be positioned in a peripheral direction. It is therefore advantageous to arrange as many paths as possible on the available surface.

FIG. 34 illustrates various positions 330, 331, 332, which the balls can take up in radial extension. Whereas movement of the balls in the region of position 331 causes little friction, the friction between the ball and the centrifugal masses increases, both when the balls move in the direction of position 332 and when the balls move in the direction of position 330.

Various types of arrangement of the paths on the discs are illustrated in FIGS. 35 and 36. Here only the main path forms are indicated. It is understood that other forms also and especially the combination of these path forms opens up further possibilities to influence the friction between the centrifugal masses.

FIGS. 37 and 38 illustrate a sprung torsional angle stopper which can be used independently of the remaining design of the torsional vibration damper. FIG. 37 illustrates a torsional vibration damper 350 with a stopper 351, indicated by reference numeral 351 in its middle position. Reference numeral 352 designates the stopper in its limit position and reference numeral 353 shows the stopper in its opposite limit position. The stopper 351 is fixed to the second centrifugal mass 354 and via springs 355, 356 acts against a bearing surface 357, 358 on the first centrifugal mass 359. Due to compression of the springs 355 and 356 the maximum torsional angle between first and second centrifugal mass is thus limited.

The upper part of FIG. 38 shows the balls 360, 361 guided in the paths in a middle position, in which minimal forces act on the saucer springs 362, 363. In this position the stopper 351 is also in a middle position, where it does not exert any power on the springs 355, 356.

In the lower part of FIG. 38 a situation is shown, in which the balls 364, 365 are lying in an outer position of the path, so that maximum forces are acting on the saucer springs 362, 363. This creates a high degree of damping. When the flywheels are in this position relative to one another the stopper 366 is in a position which leads to compression of the springs 355, 356.

The stopper 351 has either a free angle, at which the discs 359, 354 can be moved relative to one another, without the springs being compressed or the springs are in their non-compressed form until the stopper 351 cooperates with at least one of the springs at every movement.

FIG. 39 illustrates a torsional vibration damper 370, in which a guide path plate 373 is unscrewed with a screw 371 on a primary part 372. Attached to the guide path plate 373 is a slide element 374, on which the secondary part 375 is mounted rotatably. Attached to the secondary part 375 is a pin 376 which points in an axial direction to the primary part 372. Arranged between the primary part 372 and the secondary part 375 is a disc 377 illustrated in plan view in FIG. 40. This disc 377 has guide paths 378 which act on the primary part 372 via balls 379. On the opposite side of the plate 377 ball races 380 are stamped into the plate, and form guide paths for balls 381. These balls 381 cooperate with the guide path plate 373. A spring plate 382 presses the disc 377 in the direction of the first centrifugal mass 372, so that the plate 377 is tensed between the balls 379 and 381.

The pin 376 engages in a bore 383 in the disc 377, such that torsion of the first centrifugal mass relative to the second centrifugal mass results in the pin 376 holding the disc 377 and the balls 379 and 381 rolling away with motion between first and second centrifugal mass. This leads to motion of the balls 379 and 381 on the ball races 378 or 380 and due to the configuration of the ball races also leads to increased force on the disc 377, which is tensed during torsion of the centrifugal masses relative to one another as spring.

In the illustrated embodiment the ball 379 runs on an iron plate 384, since the primary part 372 is designed as a deep-draw plate, but is too soft for forming the ball race. The expert will recognise, however, that the path for the balls 379 can also be provided directly in the primary part 372.

FIG. 41 illustrates a torsional vibration damper 385 constructed substantially similarly to the torsional vibration damper 370. A spring 386, which acts in the opposite direction against a ring 387 which in turn presses the disc 388 to the secondary part 389, is provided in place of the spring 382 and the pin 376 in this torsional vibration damper.

FIG. 42 illustrates an alternative configuration of the spring 382 shown in FIG. 39. In the torsional vibration damper 390 illustrated in FIG. 42 a tangential sheet spring 391 is provided which is fixed to a first rivet 392 on the secondary part 393 and to a second rivet 394 on the disc 395. The design of such a disc 395 with a tangential sheet spring 391 is illustrated in FIG. 43. The structure of the disc 395 illustrated in FIG. 43 corresponds substantially to the structure shown in FIG. 40, with the tangential sheet spring 391 tensed between the rivets 392 and 394 also being illustrated.

FIG. 44 shows a torsional vibration damper 400, in which the abovedescribed springs 332, 386, 391 are replaced by a spring 401, which is designed integrally with the disc 402. This spring 401 is connected to the rivet 403 to the secondary part and, as for the previously described springs, provides prestressing of the disc which presses the disc against the balls 404 and 405.

1. A spring element, in particular for torsional vibration damper (1), with a sprung sheet (16, 17) which cooperates in a first region (23) with at least one rolling body (20), which opposite the first region (23) of the sprung sheet (16, 17) in a second region (25) against a stopper (22), whereby stopper (22) and sprung sheet are mounted to move relatively to one another and whereby the sprung sheet (16, 17) is bent during such a relative movement.

2. The spring element as claimed in claim 1, characterised in that the sprung sheet (16, 17) has a reinforcing bead (45).

3. The spring element as claimed in claim 1 or 2, characterised in that the sprung sheet (16, 17) has a guide for the rolling body (20).

4. The spring element as claimed in claim 3, characterised in that the guide of the sprung sheet (16, 17) is formed at least partially by deformation of the sprung sheet (16, 17).

5. The spring element as claimed in any one of claims 3 or 4, characterised in that the guide of the sprung sheet is formed at least partially by an opening (86) in the sprung sheet (82).

6. The spring element as claimed in any one of claims 3 to 5, characterised in that the guide of the sprung sheet (91) has an opposed conical form at opposite ends (93, 94) in direction of movement.

7. The spring element as claimed in any one of claims 3 to 6, characterised in that the guide of the sprung sheet (82, 91) limits the possible relative movement between sprung sheet (82, 91) and stopper (81).

8. The spring element as claimed in any one of claims 3 to 7, characterised in that the guide of the sprung sheet (91) is designed at least selectively for point or extended contact between sprung sheet (91) and rolling body (92).

9. The spring element as claimed in any one of claims 3 to 8, characterised in that the guide of the sprung sheet is designed at least selectively for two-dimensional contact between sprung sheet and rolling body.

10. The spring element as claimed in any one of the foregoing claims, characterised in that the first region (23) has a friction surface.

11. The spring element as claimed in any one of the foregoing claims, characterised in that the first region (23) is arranged in an edge region of the sprung sheet (16, 17).

12. The spring element as claimed in any one of the foregoing claims, characterised in that the stopper (22) has a guide for a rolling body (20).

13. The spring element as claimed in claim 12, characterised in that the guide of the stopper (22) is formed at least partially by deformation of the stopper (22).

14. The spring element as claimed in any one of claims 12 or 13, characterised in that the guide of the stopper (22) is formed at least partially by an opening in the stopper.

15. The spring element as claimed in any one of claims 12 to 14, characterised in that the guide of the stopper (22) has an opposed conical form on opposite ends in the direction of movement.

16. The spring element as claimed in any one of claims 12 to 15, characterised in that the guide of the stopper (22) limits the possible relative movement between sprung sheet (16, 17) and stopper (22).

17. The spring element as claimed in any one of claims 12 to 16, characterised in that the guide of the stopper (22) is designed at least selectively for extended contact between stopper (22) and rolling body (20).

18. The spring element as claimed in any one of claims 12 to 17, characterised in that the guide of the stopper (22) is designed at least selectively for two-dimensional contact between stopper (22) and rolling body (20).

19. The spring element as claimed in any one of the foregoing claims, characterised in that the second region (25) has a friction surface.

20. The spring element as claimed in any one of the foregoing claims, characterised in that several sprung sheets are placed radially behind one another.

21. The spring element as claimed in any one of the foregoing claims, characterised in that several sprung sheets are placed axially behind one another.

22. The spring element as claimed in any one of the foregoing claims, characterised in that two sprung sheets (16, 17) are arranged on opposite sides of the stopper (22).

23. The spring element as claimed in claim 22, characterised in that at least one rolling body (20) is arranged between each sprung sheet (16, 17) and stopper (22).

24. The spring element as claimed in any one of claims 22 or 23, characterised in that the sprung sheets (16, 17) are connected to one another preferably via rivets.

25. The spring element as claimed in any one of the foregoing claims, characterised in that the rolling body (20) is a sphere.

26. The spring element as claimed in any one of the foregoing claims, characterised in that the rolling body (186, 192) is a roller.

27. The spring element as claimed in any one of the foregoing claims, characterised in that the rolling body is made of steel.

28. The spring element as claimed in any one of the foregoing claims, characterised in that a lubricant is provided in the region of the rolling body (20).

29. The spring element as claimed in any one of the foregoing claims, characterised in that several rolling bodies (20) are arranged in parallel.

30. The spring element as claimed in any one of the foregoing claims, characterised in that the stopper (22) is adjacent to a first component (2) fixed on an axle.

31. The spring element as claimed in claim 30, characterised in that the stopper (22) is connected to the first component (2) by welding.

32. The spring element as claimed in claim 30, characterised in that the stopper is connected to the first component by positive locking, preferably by beads or lock seams.

33. The spring element as claimed in claim 30, characterised in that the stopper is connected to the first component by frictional connection, preferably by press fit.

34. The spring element as claimed in any one of claims 30 to 33, characterised in that the first component (2) has an additional mass (11).

35. The spring element as claimed in any one of claims 30 to 34, characterised in that the first component (2) is designed together with the stopper (22) as primary part of a torsional vibration damper (1).

36. The spring element as claimed in any one of the foregoing claims, characterised in that the sprung sheet (16, 17) is adjacent to a second component (3), preferably mounted on an axle.

37. The spring element as claimed in claim 36, characterised in that the second component (3) is designed as secondary part of a torsional vibration damper (1).

38. The spring element as claimed in claim 36 or 37, characterised in that the sprung sheet is connected to the second component (3) by positive locking, preferably by rivets.

39. The spring element as claimed in claim 36 or 37, characterised in that the sprung sheet is connected to the second component (3) by screwing.

40. The spring element as claimed in any one of claims 36 to 39, characterised in that a shielding plate is arranged between sprung sheet (16, 17) and second component (3).

41. The spring element as claimed in any one of claims 36 to 40, characterised in that a bearing (33) is arranged between the second component (3) and the axle.

42. The spring element as claimed in claim 41, characterised in that the bearing between second component (3) and axle has a bearing shell (38) which is preferably L-shaped.

43. The spring element as claimed in claim 41, characterised in that the bearing shell (38) has an axial bearing with a first shell element (40) and a radial bearing with a second shell element (39).

44. The spring element as claimed in any one of the foregoing claims, characterised in that first and/or second region (23, 25) is designed as a bearing.

45. The spring element as claimed in any one of claims 36 to 44, characterised in that an outer peripheral surface of the first component (2) and an inner peripheral surface of the second component (3) is designed as a bearing.

46. The spring element as claimed in any one of claims 36 to 44, characterised in that a bearing (33) is built in between first and second component at a distance from the axle (36).

47. The spring element as claimed in any one of the foregoing claims, characterised in that the sprung sheet (16, 17) is constructed substantially centrically to an axis of rotation (36).

48. The spring element as claimed in any one of the foregoing claims, characterised in that the sprung sheet (16, 17) is designed as a saucer spring.

49. The spring element as claimed in any one of the foregoing claims, characterised in that the stopper (22) has a saucer spring.

50. The spring element as claimed in any one of the foregoing claims, characterised in that stopper (22) and sprung sheet (16, 17) are mounted rotatably relative to one another.

51. The spring element as claimed in claim 50, characterised in that first and/or second region (23, 25) enable additional mobility between stopper (22) and sprung sheet (16, 17) for rotatability.

52. The spring element as claimed in any one of the foregoing claims, characterised in that it has damping agent (53).

53. The spring element as claimed in claim 52, characterised in that the damping agent is positioned on the sprung sheet or on the second component and acts against the stopper or the first component.

54. The spring element as claimed in claim 52, characterised in that the damping agent (53) is arranged on the stopper (64) or on the first component (51) and acts against the sprung sheet (63) or the second component (57).

55. The spring element as claimed in any one of claims 52 to 54, characterised in that the damping agent has an effective surface with fine profiling.

56. The spring element as claimed in any one of claims 52 to 55, characterised in that the damping agent has an effective surface with an axial incline.

57. The spring element as claimed in any one of claims 52 to 55, characterised in that the damping agent has an effective surface with a radial incline.

58. The spring element as claimed in any one of claims 56 or 57, characterised in that a part of the effective surface is developed without incline.

59. The spring element as claimed in any one of claims 52 to 58, characterised in that the damping can be varied relative to the speed of the rotatory motion of stopper (107) and sprung sheet (105, 106).

60. The spring element as claimed in any one of claims 52 to 59, characterised in that the damping agent (109, 110) has a mass which is subjected to centrifugal force when rotating such that it alters the damping.

61. The spring element as claimed in any one of claims 52 to 60, characterised in that the damping agent has a damping adjustment spring (71, 72).

62. The spring element as claimed in claim 61, characterised in that the damping adjustment spring (71, 72) is arranged coaxially to the spring element.

63. The spring element as claimed in claim 61, characterised in that the damping adjustment spring is arranged radially offset from an axis of rotation (73).

64. The spring element as claimed in any one of claims 52 to 63, characterised in that the sprung sheet is designed such that the contact force of the sprung sheet on the rolling bodies is altered during rotation.

65. The spring element as claimed in any one of claims 52 to 64, characterised in that the sprung sheet is designed such that the contact force of the sprung sheet on a bearing shell is altered during rotation.

66. The spring element as claimed in any one of claims 52 to 65, characterised in that two sprung sheets arranged on opposite sides of the stopper exhibit different resilient strengths.

67. The spring element as claimed in any one of claims 52 to 66, characterised in that rolling bodies arranged on opposite sides of the stopper are guided on diverging and/or converging paths.

68. The spring element as claimed in any one of claims 52 to 67, characterised in that the damping agent has at least one arm (109, 110) extending in a peripheral direction, which acts preferably radially against a friction surface.

69. The spring element as claimed in claim 68, characterised in that the arm (109, 110) is connected to the stopper (107) or the first component and the friction surface to the sprung sheet (102, 103).

70. The spring element as claimed in any one of claims 52 to 69, characterised in that the spring element is a torque converter.

71. The spring element as claimed in any one of the foregoing claims, characterised in that the spring element is arranged between a stopper and a friction coating.

72. The spring element as claimed in any one of the foregoing claims, characterised in that the position of the bearing areas is such that forced slippage occurs between sprung sheet and stopper.

73. The spring element as claimed in claim 72, characterised in that two sprung sheets (262, 263) connected to one another torsionally rigidly and rotating about an axis of rotation act on an interposed stopper (261) and the connecting axle between first and second bearing area is arranged at an angle (β) to the axis of rotation.

74. The spring element as claimed in any one of the foregoing claims, characterised in that the sprung sheet is designed from a disc (277) and a leaf spring (271).

75. The spring element as claimed in any one of the foregoing claims, characterised in that stopper and sprung sheet are mounted via a glide bearing (313) relative to one another.

76. The spring element as claimed in any one of the foregoing claims, characterised in that stopper and sprung sheet are mounted via a roller bearing (393, 394), in particular a needle bearing, relative to one another.

77. The spring element as claimed in any one of the foregoing claims, characterised in that it has a guide for rolling bodies, which guides the rolling bodies with a radial motion component.

78. The spring element as claimed in any one of the foregoing claims, characterised in that it has a spring-loaded torsional angle stopper.

79. The spring element as claimed in any one of the foregoing claims, characterised in that the sprung sheet (377) acts in radially spaced areas together with rolling bodies (379, 381).

80. The spring element as claimed in any one of the foregoing claims, characterised in that the sprung sheet (377) is pressed by means of a spring (382) against the rolling bodies (379, 381).

81. The spring element as claimed in claim 80, characterized in that the spring (401) is a part of the sprung sheet (402).
